(19) United States
(12) Patent Application Publication
(10) Pub. No.: US 2001/0013823 A1
(43) Pub. Date: Aug. 16, 2001

(54) NETWORK CONTROL SYSTEM, NETWORK TERMINAL AND CONTROL TERMINAL

(76) Inventors: TAKESHI HATAKEYAMA, OSAKA-SHI (JP); MITSURU KITAO, YAMATOKORIYAMA-SHI (JP); KEN-ICHI MORIGUCHI, NEYAGAWA-SHI (JP)

Correspondence Address: ANDREW L NEY, RATNER & PRESTIA, ONE WESTLAKES BERWYN, P O BOX 980 SUITE 301, VALLEY FORGE, PA, 194820980

(21) Appl. No.: 09/060,032

(22) Filed: Apr. 13, 1998

(30) Foreign Application Priority Data
Apr. 14, 1997 (JP) 9-095473

(51) Int. Cl. G05B 23/02

(52) U.S. Cl. 340/3.1; 340/3.5; 340/3.71

(57) ABSTRACT

A network control system is provided which includes: a network terminal; and a control terminal. The network terminal transmits to the control terminal manipulation information indicating a type of at least one manipulation component and a manipulation requesting signal corresponding to the manipulation component, receives from the control terminal the manipulation requesting signal, and performs an operation corresponding to the manipulation requesting signal upon receipt of the manipulation requesting signal from the control terminal. The control terminal includes at least one manipulation component, receives and analyzes the manipulation information from the network terminal, selects the type of the manipulation component indicated by the manipulation information, corresponds the selected manipulation component and the manipulation requesting signal indicated by the manipulation information, thereby establishing a manipulation environment for controlling the network terminal, and, when the manipulation component is selectively manipulated, transmits the manipulation requesting signal to the network terminal.

### BACKGROUND OF THE INVENTION

1. FIELD OF THE INVENTION

The present invention relates to a control terminal, a network terminal and a network control system in which the control terminal is connected to the network terminal via a network for remotely controlling the network terminal.

2. DESCRIPTION OF THE RELATED ART

It is well known that remote controllers for controlling televisions, video players, air conditioners and the like need to be manipulated separately, thereby rendering manipulations of the apparatuses complicated.

Therefore, a system for remotely controlling a plurality of unspecified network terminals with one remote controller has been proposed. According to this system, a network terminal and a control terminal are combined, whereby the network terminal provides control information to the control terminal. Based on this control information, a manipulation environment for remotely controlling the network terminal is established on the control terminal side.

Such systems are described in, for example, Japanese Laid-Open Publication Nos. 8-140167 and 8-149576. According to the above-described publications, control information including a plurality of commands and a plurality of icons corresponding thereto is stored in the network terminal. The control information is transmitted from the network terminal to the control terminal. The control terminal analyzes the control information and displays an icon for each of the manipulation buttons, thereby establishing a manipulation environment. The manipulation buttons are selectively pressed by a user referring to these icons, whereby a signal indicating a command corresponding to the selected manipulation button is transmitted from the control terminal to the network terminal. In response to the signal indicating the command, the network terminal executes the command and performs a predetermined operation.

FIG. 1 is a block diagram showing a conventional network control system 100. Referring to FIG. 1, a control terminal 11 includes a selection device 111, a transmitting data generator 112, a transmitter 113, a display device 114, a control code table RAM 115, a display controller 116, a received data analyzer 117, a receiver 118 and a display font RAM 119. The network terminal 12 includes a receiver 121, a received data analyzer 122, a control code table ROM 123, a network terminal controller 124, a transmitter 125, a transmitting data generator 126 and a display font ROM 127.

FIG. 2 is a schematic diagram showing a video apparatus 21 which is provided with the network terminal 12. Each of control information including a command and an icon corresponding thereto is transmitted from the network terminal 12 to the control terminal 11 as an infrared signal, whereby the control information is downloaded to the control terminal 11. The control terminal 11 receives and analyzes the control information and displays five icons on the display device 114 indicating corresponding operations (i.e., rewind, reverse play, stop, play and fast forward). The selection device 111 includes a plurality of manipulation buttons. Icons corresponding to the manipulation buttons respectively are displayed. As a result, a manipulation environment for remotely controlling the video apparatus 21 is established on the control terminal 11. For example, when a manipulation button corresponding to an icon indicating “rewind” is pressed, a signal indicating a command for rewinding is transmitted from the control terminal 11 to the network terminal 12. In response to the signal indicating the rewind command, the network terminal 12 executes the command and instructs the video player 21 to rewind.

Hereinafter, the above-described operation will be described in more detail.

In the network terminal 12, the commands for controlling the network terminal 12 are stored in the control code table ROM 123. Icons corresponding to these commands are stored in the display font ROM 127. FIG. 3 is a table 31 showing examples of the commands and the icons corresponding thereto. Each command and each icon corresponding thereto form manipulation information.

The transmitting data generator 126 of the network terminal 12 fetches a command from the control code table ROM 123 as well as an icon corresponding thereto from the display font ROM 127, thereby forming manipulation information by combining the command and the icon. The manipulation information is provided to the transmitter 125. The transmitter 125 transmits the manipulation information to the control terminal 11.

The receiver 118 of the control terminal 11 receives the manipulation information and provides the manipulation information to the received data analyzer 117. The received data analyzer 117 analyzes the manipulation information, and stores the command in the control code table RAM 115 and the icon corresponding to the command in the display font RAM 119.

The icon stored in the display RAM 119 is read out by the display controller 116 and is displayed by the display device 114. In this way, icons are displayed as shown in FIG. 2, whereby the user can see the functions of the manipulation buttons of the selection device 111.

When one of the manipulation buttons is selectively pressed by the user, the transmitting data generator 112 refers to the control code table RAM 115 and fetches a command corresponding to the pressed manipulation button. For example, when the manipulation button corresponding to the icon representing “rewind” shown in FIG. 2 is pressed by the user, the transmitting data generator 112 fetches command 3 shown in FIG. 3 from the control code table RAM 115 and transmits the signal indicating the command 3 from the transmitter 113 to the network terminal 12.

The receiver 121 of the network terminal 12 receives the signal indicating the command 3, and provides the command 3 to the received data analyzer 122. The received data analyzer 122 analyzes the command 3 and requests to the network terminal controller 124 to perform the desired operation. The network terminal controller 124 executes the command 3 and instructs the video player 21 to rewind.

In the above-described manner, the manipulation information is transmitted from the network terminal 12 to the control terminal 11, whereby a manipulation environment for remotely controlling the network terminal 12 is established in the control terminal 11.

Even when a plurality of unspecified network terminals are used, manipulation environments for remotely controlling the network terminals can be established based on manipulation information which is provided from the network terminals to the control terminal when the network terminals are combined with the control terminal. A manipulation environment for remotely controlling the network is established for each network terminal. By registering the manipulation environments in the control terminal, the plurality of network terminals can be remotely controlled by one control terminal.

However, the above-described conventional network control system 100 has the following problems.

In the conventional network control system 100, even a manipulation button, for example, a power button, which performs a same operation to all of the network terminals, is set by transmitting a combination of a command and an icon thereof from the network terminal to the control terminal. As a result, such a button may not be arranged in the same way for all of the network terminals.

Since commands and icons are transmitted for all of the manipulation buttons from the network terminal to the control terminal, the amount of transmitted information is large, which requires a long time for transmitting the information. For example, when one icon is represented by a 16×16 bit map, a total of 256 bits need to be transmitted. When the information transmission rate by an infrared signal from the network terminal to the control terminal is 200 bits per second, a transmission time of 1 second or more is required for each icon.

According to the conventional network control system 100, there is no function of collectively arranging a plurality of related manipulation buttons instructing similar functions, for example, a pair of volume buttons for instructing “Volume up” and “Volume down”. In this case, therefore, the pair of volume buttons may not be collectively arranged in convenient positions.

According to the conventional network control system 100, although a plurality of network terminals can be remotely controlled by one control terminal, they cannot be collectively controlled. For example, when one application is realized by a plurality of network terminals, each of the networks needs to be remote controlled by the control terminal separately.

### SUMMARY OF THE INVENTION

According to one aspect of the present invention, a network control system is provided which includes: a network terminal; and a control terminal. The network terminal transmits to the control terminal manipulation information indicating a type of at least one manipulation component and a manipulation requesting signal corresponding to the manipulation component, receives from the control terminal the manipulation requesting signal, and performs an operation corresponding to the manipulation requesting signal upon receipt of the manipulation requesting signal from the control terminal. The control terminal includes at least one manipulation component, receives and analyzes the manipulation information from the network terminal, selects the type of the manipulation component indicated by the manipulation information, corresponds the selected manipulation component and the manipulation requesting signal i dicated by the manipulation information, thereby establishing a manipulation environment for controlling the network terminal, and, when the manipulation component is selectively manipulated, transmits the manipulation requesting signal to the network terminal.

In accordance with one embodiment of the present invention, a predetermined manipulation component of the at least one manipulation component predeterminedly corresponds to a predetermined operation of the network terminal.

In accordance with one embodiment of the present invention, the at least one manipulation component is assigned to a physical manipulation button of the control terminal.

In accordance with one embodiment of the present invention, the at least one manipulation component is assigned to a manipulation button displayed on a display section of the control terminal.

In accordance with one embodiment of the present invention, the at least one manipulation component includes manipulation components belonging to a manipulation component group, and the control terminal collectively processes the manipulation component of the manipulation component group.

In accordance with one embodiment of the present invention, the network control system includes a plurality of network terminals, at least one of which identifies an application which can be realized by exchanging function information among the plurality of network terminals; transmits to the control terminal manipulation information indicating a type of at least one manipulation component for controlling the function and a manipulation requesting signal corresponding to the manipulation component, receives the manipulation requesting signal from the control terminal, and performs an operation corresponding to the manipulation requesting signal upon receipt of the manipulation requesting signal from the control terminal.

In accordance with one embodiment of the present invention, the control terminal is a remote controller for remotely controlling the network terminal.

According to another aspect of the present invention, a network terminal is provided which is controlled by a control terminal including at least one manipulation component. The network terminal transmits to the control terminal manipulation information indicating a type of at least one manipulation component and a manipulation requesting signal corresponding to the manipulation component, receives manipulation requesting signal, and performs an operation corresponding to the manipulation requesting signal upon receipt of the manipulation requesting signal from the control terminal.

In accordance with one embodiment of the present invention, a predetermined manipulation component of the at least one manipulation component of the control terminal predeterminedly corresponds to a predetermined operation of the network terminal.

In accordance with one embodiment of the present invention, the at least one manipulation component includes a manipulation components belonging to a manipulation component group, and the control terminal collectively processes the manipulation component of the manipulation component group.

In accordance with one embodiment of the present invention, the network terminal identifies an application which can be realized by exchanging function information among a plurality of network terminals, transmits to the control terminal manipulation information indicating a type of at least one manipulation component for controlling the function and a manipulation requesting signal corresponding to the manipulation component, and performs an operation corresponding to the manipulation requesting signal upon receipt of the manipulation requesting signal from the control terminal.

According to still another aspect of the present invention, a network terminal is provided which is controlled by a control terminal including at least one manipulation component. The network terminal includes: a memory section for storing manipulation information indicating a type of the at least one manipulation component and a manipulation requesting signal corresponding to the manipulation component; a two-way communication section for transmitting to the control terminal the manipulation information stored in the memory section, and receiving the manipulation requesting signal from the control terminal; and a control section for performing an operation corresponding to the manipulation requesting signal in response to the manipulation requesting signal received by the two-way communication section.

According to still another aspect of the present invention, a control terminal for controlling a network terminal is provided which performs an operation in response to a manipulation requesting signal. The control terminal including at least one manipulation component receives and analyzes manipulation information from the network terminal and selects a type of the manipulation component indicated by the manipulation information, corresponds the selected manipulation component and the manipulation requesting signal indicated by the manipulation information, thereby establishing a manipulation environment for controlling the network terminal, and, when the manipulation component is selectively manipulated, transmits the manipulation requesting signal to the network terminal.

In accordance with one embodiment of the present invention, a predetermined manipulation component of the at least one manipulation component predeterminedly corresponds to a predetermined operation of the network terminal.

In accordance with one embodiment of the present invention, the at least one manipulation component is assigned to a physical manipulation button of the control terminal.

In accordance with one embodiment of the present invention, the at least one manipulation component is assigned to a manipulation button displayed on a display section of the control terminal.

In accordance with one embodiment of the present invention, the at least one manipulation component includes manipulation components belonging to a manipulation component group, and the control terminal collectively processes the manipulation component of the manipulation component group.

In accordance with one embodiment of the present invention, the control terminal is a remote controller for remotely controlling the network terminal.

According to still another aspect of the present invention, a control terminal for controlling a network terminal for performing an operation in response to a manipulation requesting signal from the control terminal. The control terminal includes: at least one manipulation component; a two-way communication section for receiving manipulation information from the network terminal and transmitting a manipulation requesting signal to the network terminal; and a control section which analyzes the manipulation information received via the two-way communication system, selects a type of the manipulation component indicated by the manipulation information, corresponds the selected manipulation component and the manipulation requesting signal indicated by the manipulation information, thereby establishing a manipulation environment for controlling the network terminal, and, when the manipulation component is selectively manipulated, transmits the manipulation requesting signal to the network terminal via the two-way communication section.

According to still another aspect of the present invention, a network control system is provided which includes: a plurality of network terminals, at least one of which identifies an application which can be realized by exchanging function information among the plurality of network terminals, transmits to the control terminal manipulation information indicating a manipulation environment for controlling the function and a manipulation requesting signal corresponding to the manipulation component, receives the manipulation requesting signal from the control terminal, and performs an operation corresponding to the manipulation requesting signal upon receipt of the manipulation requesting signal from the control terminal; and a control terminal which receives and analyzes the manipulation information, establishes the manipulation environment indicated by the manipulation information, and when the manipulation environment is manipulated intended for the function, transmits the manipulation requesting signal to at least one of the network terminals.

According to still another aspect of the present invention, a plurality of network terminals which are controlled by a control terminal including at least one manipulation component are provided. At least one of the plurality of network terminals identifies an application which can be realized by exchanging function information among the plurality of network terminals, and transmits to the control terminal manipulation information indicating a manipulation environment for controlling the function and a manipulation requesting signal, and performs an operation corresponding to the function upon receipt of the manipulation requesting signal from the control terminal.

Thus, the invention described herein makes possible the advantages of providing: (1) a network control system in which the amount of manipulation information transmitted from a network terminal to a control terminal is reduced; (2) a network control system in which manipulation components which perform same operations to a plurality of network terminals are already provided in the control terminal so as to provide the control terminal with a usable manipulation environment; (3) a network control system in which related manipulation components are set in the control terminal as a group so as to provide the control terminal with a usable manipulation environment; and (4) a network control system in which a manipulation environment for remotely controlling an application which is provided by a plurality of network terminals can be automatically set.

These and other advantages of the present invention will become apparent to those skilled in the art upon reading and understanding the following detailed description with reference to the accompanying figures.

### BRIEF DESCRIPTION OF THE DRAWINGS

FIG. 1 is a block diagram showing a conventional network control system;

FIG. 2 is a schematic diagram showing a video apparatus which is provided with the network terminal shown in FIG. 1;

FIG. 3 is a table showing examples of commands and icons corresponding thereto in the network control system shown in FIG. 1;

FIG. 4A is a block diagram schematically showing a network control system according to a first example of the present invention;

FIG. 4B is a schematic sequence chart showing a communication protocol of the network control system according to the first example of the present invention;

FIG. 5 is a block diagram showing an exemplary application of the network control system according to the first example of the present invention;

FIG. 6 is a view showing the external appearance of a control terminal in the network control system according to the first example of the present invention;

FIG. 7A shows a manipulation environment of the control terminal of FIG. 6 for the television terminal;

FIG. 7B shows a manipulation environment of the control terminal of FIG. 6 for the video terminal;

FIG. 7C shows a manipulation environment of the control terminal 41 of FIG. 6 for the image receiver terminal;

FIG. 8 is a data table showing types of the manipulation components according to the first example of the present invention;

FIG. 9 is a diagram showing manipulation information for establishing the manipulation environment shown in FIG. 7A for remotely controlling the television terminal of the network control system according to the first example of the present invention;

FIG. 10 is a diagram showing manipulation information for establishing the manipulation environment shown in FIG. 7B for remotely controlling the video terminal of the network control system according to the first example of the present invention;

FIG. 11 is a diagram showing manipulation information for establishing the manipulation environment shown in FIG. 7C for remotely controlling the image receiver terminal in the network control system according to the first example of the present invention;

FIG. 12 is a flow diagram showing processes performed by the control terminal of the network control system according to the first example of the present invention;

FIG. 13 is a schematic diagram showing a network control system according to a second example of the present invention;

FIG. 14 is a view showing a manipulation environment for remotely controlling a car navigation system established on the control terminal according to the second example of the present invention;

FIG. 15 is a diagram showing a manipulation information for establishing the manipulation environment shown in FIG. 14 for remotely controlling the car navigation system in the network control system according to the second example of the present invention;

FIG. 16 is a view showing a plurality of display screens according to the second example of the present invention;

FIG. 17 is a view showing a plurality of display screens in the conventional system;

FIG. 18 is a block diagram schematically showing a network control system according to a third example of the present invention;

FIG. 19 is a table showing function information which is exchanged among the network terminals according to the third example of the present invention;

FIG. 20 is a block diagram schematically showing a network control system according to a fourth example of the present invention;

FIGS. 21A through 21C are views showing display screens according to the fourth example of the present invention, respectively;

FIG. 22 is a table showing function information which is exchanged among the network terminals according to the fourth example of the present invention;

FIG. 23 is a diagram showing manipulation information for establishing a manipulation environment shown in FIG. 21A for remotely controlling a video player of the network control system according to the fourth example of the present invention;

FIG. 24 is a diagram showing the manipulation information for establishing the manipulation environment shown in FIG. 21B for remotely controlling the video player of the network control system according to the fourth example of the present invention;

FIG. 25 is a diagram showing the manipulation information for establishing the manipulation environment for remotely controlling a car navigation system of the network control system according to the fourth example of the present invention; and

FIG. 26 is a diagram showing the manipulation information for establishing the manipulation environment shown in FIG. 21C for remotely controlling the car navigation system of the network control system according to the fourth example of the present invention.

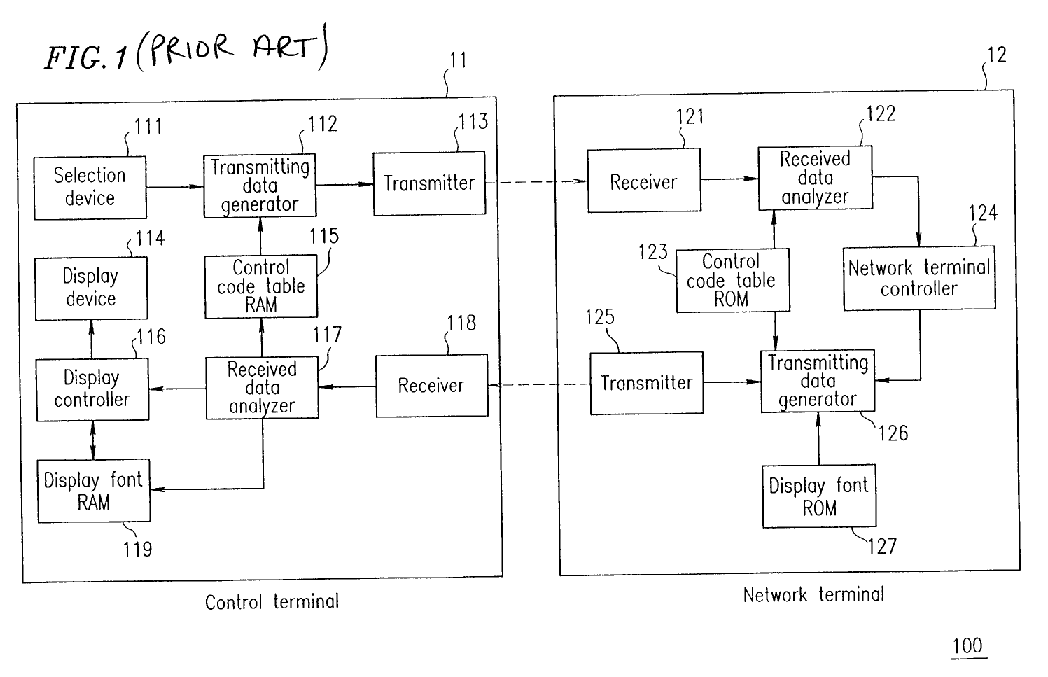

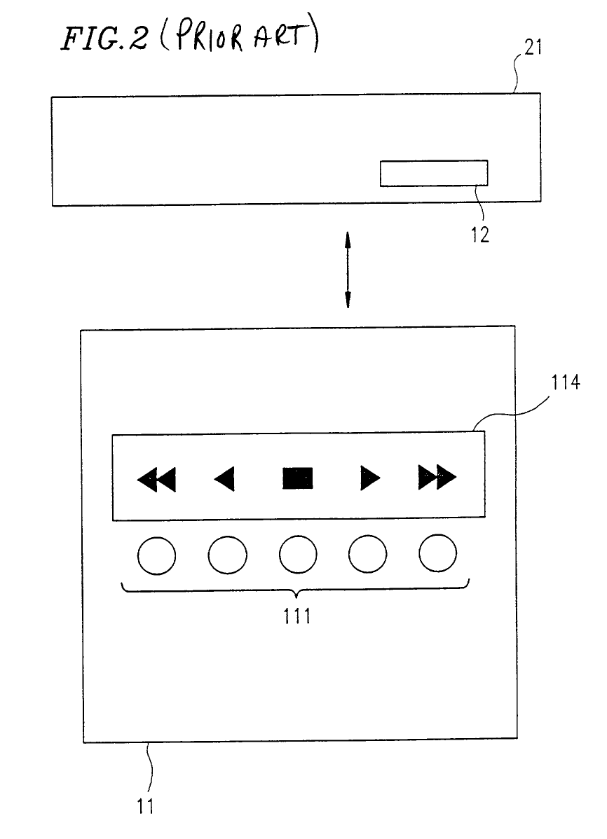

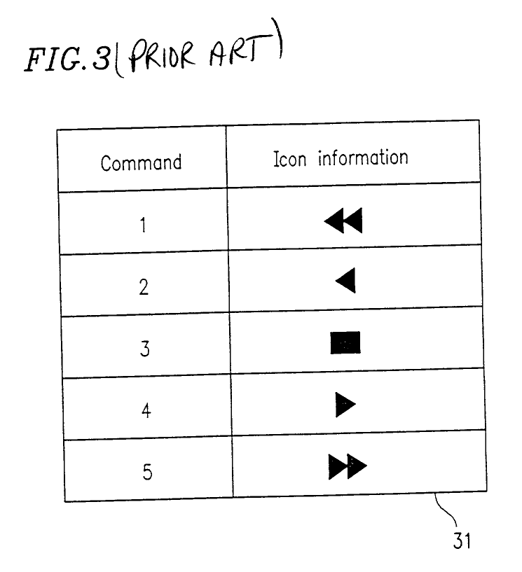

### DESCRIPTION OF THE PREFERRED EMBODIMENTS

Hereinafter, the present invention will be described by way of illustrative examples with reference to the accompanying drawings.

### EXAMPLE 1

Hereinafter, a network control system 400 including a control terminal 41 and a network terminal 43 according to a first example of the present invention will be described.

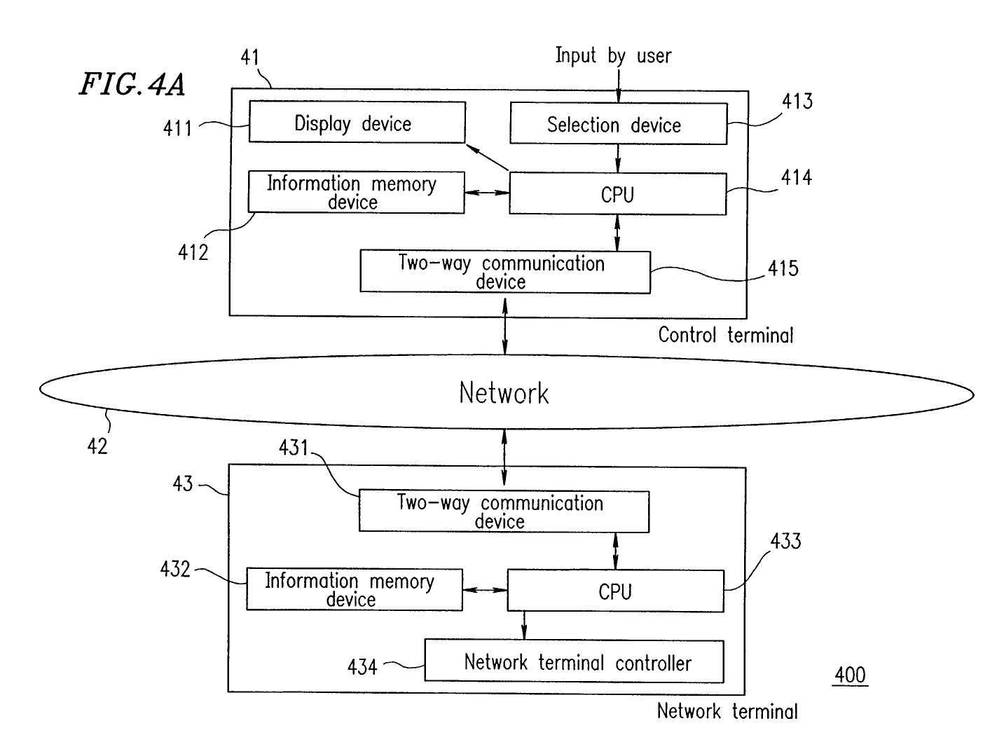

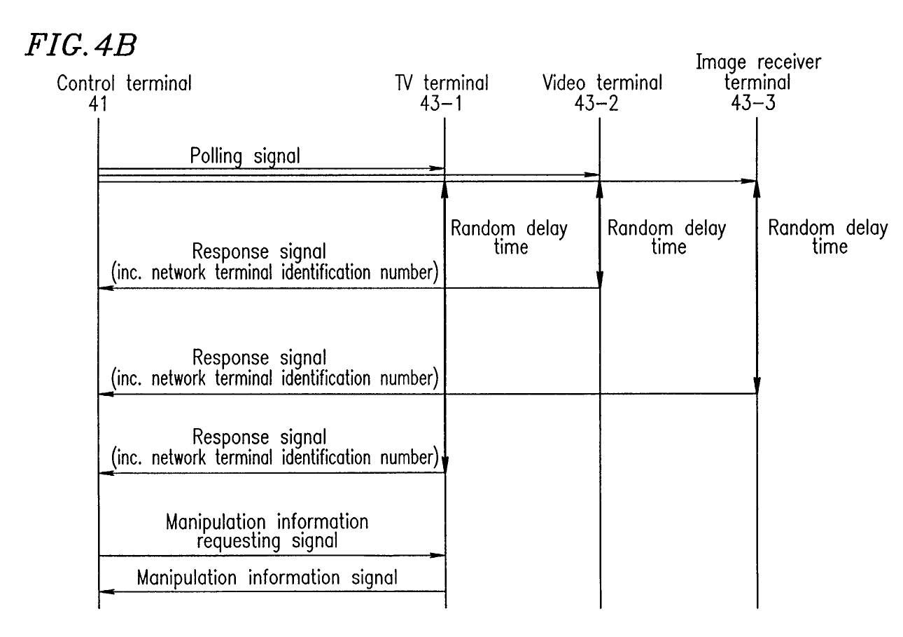

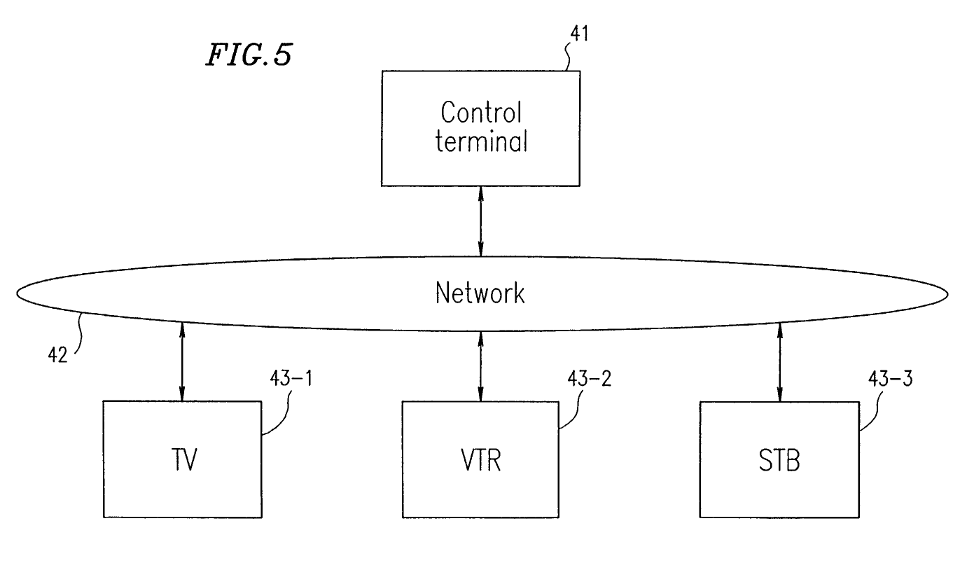

FIG. 4A is a block diagram schematically showing the network control system 400 according to the first example of the present invention. FIG. 5 is a block diagram showing an exemplary application of the network control system 400 according to the first example of the present invention.

Referring to FIG. 4A, the network control system 400 includes the control terminal 41, the network terminal 43 and a network 42. The network 42 provides connections between the control terminal 41 and a respective one of a television terminal 43-1 (FIG. 5), a video terminal 43-2 (FIG. 5) and an image receiver terminal (Set Top Box) 43-3 (FIG. 5). The television terminal 43-1, the video terminal 43-2 and the image receiver terminal 43-3 are network terminals 43 which are remotely controlled by one control terminal 41. The network terminal 43 shown in FIG. 4A may be any one of the television terminal 43-1, the video terminal 43-2 or the image receiver terminal 43-3. In the figure, only common components of the network terminals 43 are shown.

Referring to FIG. 5, the network 42 providing connections between the control terminal 41 and respective one of the television terminal 43-1, the video terminal 43-2 and the image receiver terminal 43-3 is shown.

Returning to FIG. 4A, the control terminal 41 includes a display device 411, an information memory device 412, a selection device 413, a central processing unit (hereinafter, simply referred to as a “CPU”) 414 and a two-way communication device 415. The network terminal 43 includes a two-way communication device 431, an information memory device 432, a CPU 433 and a network terminal controller 434.

The network 42 is an infrared network which enables two-way communication between the control terminal 41 and the network terminal 43.

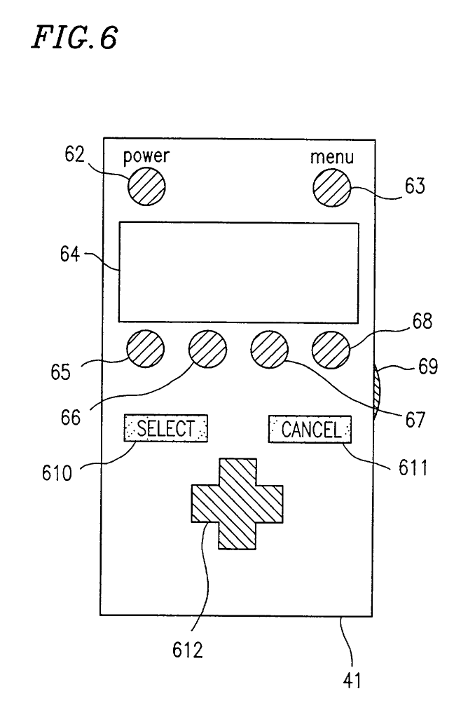

FIG. 6 is a plan view showing the appearance of the control terminal 41. Referring to FIG. 6, the control terminal 41 has a power button 62, a menu button 63, a display panel 64 of the display device 411, variable buttons 65, 66, 67 and 68, a jog dial 69, a select button 610, a cancel button 611 and a cross-shaped button 612. The above-described buttons are included in the selection device 413.

The power button 62 performs a same operation to each of the network terminals 43-1, 43-2 and 43-3, and turns the network terminals 43 on and off.

The menu button 63 performs a same operation to each of the network terminals 43-1, 43-2 and 43-3, and is used to call a menu for each of the network terminals 43.

The variable buttons 65, 66, 67 and 68 are assigned with functions unique to each of the network terminals 43-1, 43-2 and 43-3, for remotely controlling the network terminals 43-1, 43-2 and 43-3. The functions of the variable buttons 65, 66, 67 and 68 are displayed on the display panel 64. In other words, the display panel 64 displays icons and text corresponding to the variable buttons 65, 66, 67 and 68, thereby representing the functions unique to the network terminals 43-1, 43-2 and 43-3.

The jog dial 69 is used for selecting the network terminal 43-1, 43-2 or 43-3 which is to be remotely controlled. By rotating the jog dial 69, the network terminal 43-1, 43-2 or 43-3 can be switched from one to another.

The select button 610 and the cancel button 611 perform same operations to the network terminals 43-1, 43-2 and 43-3. The select button 610 and the cancel button 611 are used to select menu displayed on a display panel of the network terminal 43-1, 43-2 or 43-3, or to cancel the selected menu.

The cross-shaped button 612 performs the same operation to the network terminals 43-1, 43-2 and 43-3.

The cross-shaped button 612 is used to move a cursor on the menu displayed on the display panel of the network terminal 43-1, 43-2 or 43-3.

The power button 62, the menu button 63, the select button 610, the cancel button 611 and the cross-shaped button 612 perform the same operations to the network terminals 43-1, 43-2 and 43-3. Since each of these buttons has a fixed position and a fixed function, a user can easily manipulate the control terminal 41.

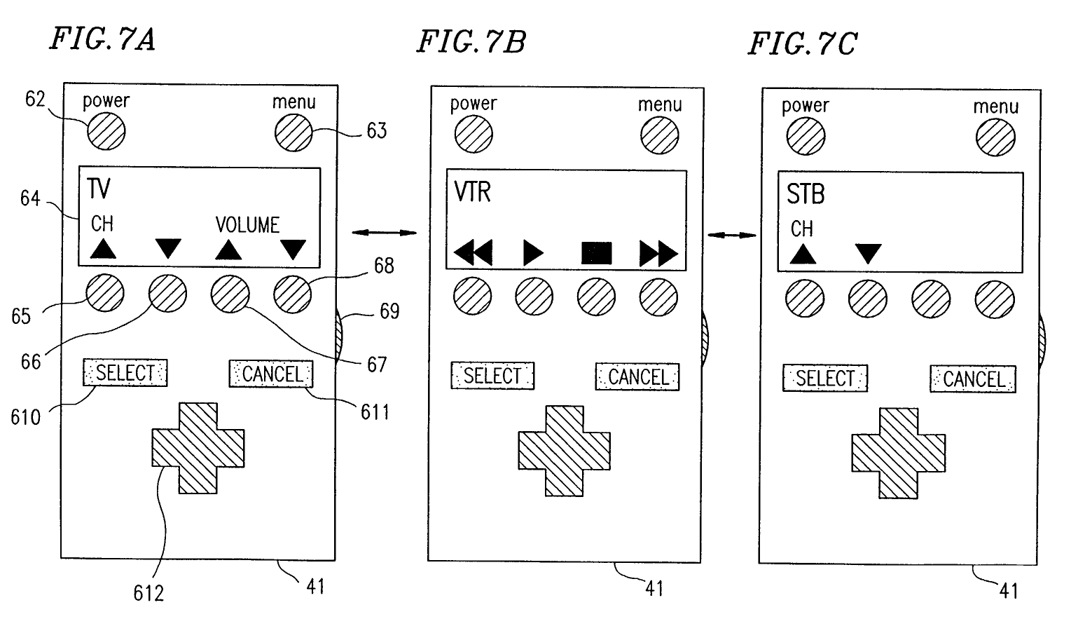

FIGS. 7A, 7B and 7C are plan views showing the manipulation environments of the control terminal 41 for the television terminal 43-1, the video terminal 43-2 and the image receiver terminal 43-3, respectively.

FIG. 7A shows the manipulation environment of the control terminal 41 for the television terminal 43-1. Referring to FIG. 7A, text “TV” appears on the upper left corner of the display panel 64, indicating that the television terminal 43-1 is selected. Only the power button 62 is validated as a common operation button. The variable buttons 65, 66, 67 and 68 are assigned with the commands “channel up”, “channel down”, “volume up” and “volume down”, respectively. Icons indicating the respective functions are displayed on the display panel 64 so as to correspond to the variable buttons 65, 66, 67 and 68, respectively.

FIG. 7B shows the manipulation environment of the control terminal 41 for the video terminal 43-2. Referring to FIG. 7B, text “VTR” appears on the upper left corner of the display panel 64, indicating that the video terminal 43-2 is selected. Only the power button 62 is validated as a common operation button. The variable buttons 65, 66, 67 and 68 are assigned with the commands “rewind”, “play”, “stop” and “fast forward”, respectively. Icons indicating the respective functions are displayed on the display panel 64 so as to correspond to the variable buttons 65, 66, 67 and 68, respectively.

FIG. 7C shows the manipulation environment of the control terminal 41 for the image receiver terminal 43-3. Referring to FIG. 7C, text “STB” appears on the upper left corner of the display panel 64, indicating that the image receiver terminal 43-3 is selected. The power button 62, the menu button 63, the select button 610, the cancel button 611 and the cross-shaped button 612 are validated as common operation buttons. The two variable buttons 65 and 66 are assigned with the commands “channel up” and “channel down”, respectively. Icons indicating the respective functions are displayed on the display panel 64 so as to correspond to the variable buttons 65 and 66, respectively.

In the above-described manipulation environments, text indicating the selected network terminal 43 to be controlled is always displayed on the upper left corner of the display panel 64. Therefore, the user can see which network terminal 43 is presently selected. By rotating the jog dial 69, the network terminal 43 to be controlled can be switched among the television terminal 43-1, the video terminal 43-2 and the image receiver terminal 43-3, whereby the manipulation environment corresponding to the selected network terminal 43 is switched as well.

In order to set the above-described manipulation environments in the control terminal 41 to remotely control the network terminal 43, the manipulation environment for each network terminal 43 needs to be registered in the control terminal 41 in advance. When the network terminal 43 is connected to the network 42, e.g., the infrared network, manipulation information defining a manipulation environment is transmitted from the network terminal 43 to the control terminal 41, thereby registering the manipulation environment for remotely controlling the network terminal 43.

Hereinafter, a process for registering the manipulation environment for remotely controlling the network terminal 43 will be described in detail.

FIG. 4B is a schematic sequence chart showing a communication protocol of the network control system 400 according to the first example of the present invention.

The control terminal 41 periodically transmits a polling signal to each of the network terminals 43 via the infrared network 42 in a manner represented by the sequence chart shown in FIG. 4B.

Specifically, the CPU 414 of the control terminal 41 periodically transmits the polling signal to the infrared network 42 via the two-way communication device 415.

Each of the network terminals 43 receives the polling signal via the two-way communication device 431 and inputs the polling signal to the CPU 433. Upon receiving the polling signal, the CPU 433 of the network terminals 43 generates a response signal including an identification number of the corresponding network terminal 43, thereby transmitting the response signal to the infrared network 42.

In the above-described manner, the response signals corresponding to the network terminals 43 are transmitted to the control terminal 41. Each of the network terminals 43 has a predetermined response delay time. The response signal is transmitted from each network terminal 43 with the respective predetermined response delay time after receiving the polling signals. Accordingly, competition between the response signals corresponding to each network terminals 43 is prevented.

The two-way communication device 415 of the control terminal 41 sequentially receives the response signal from each of the network terminals 43 and sequentially inputs the response signal to the CPU 414. The CPU 414 recognizes each identification number included in the response signals and stores the identification number in the information memory device 412. The CPU 414 collates the identification numbers with the identification numbers previously stored in the information memory device 412. Accordingly, the network terminal 43 which is to be newly registered is recognized by the control terminal 41, and the identification number for the network terminal 43 to be newly registered is stored in the control terminal 41.

Hereinafter, an exemplary case will be described where the identification numbers of the video terminal 43-2 and the image receiver terminal 43-3 are already stored in the control terminal 41 and the identification number of the television terminal 43-1 is to be newly registered in the control terminal 41.

Since the identification numbers of the video terminal 43-2 and the image receiver terminal 43-3 are already stored in the control terminal 41 at this point, the manipulation environments for remotely controlling the video terminal 43-2 and the image receiver terminal 43-3 are already registered in the control terminal 41. On the other hand, the manipulation environment for remotely controlling the television terminal 43-1 has not yet been registered in the control terminal 41.

The manipulation environment for remotely controlling the television terminal 43-1 is registered as follows.

The CPU 414 of the control terminal 41 generates signals requesting manipulation information including the identification number of the television terminal 43-1, and transmits the manipulation information requesting signals to the television terminal 43-1 via the two-way communication device 415.

The manipulation information requesting signals are input to the CPU 433 of the television terminal 43-1, whereby the CPU 433 confirms the identification number of the television terminal 43-1 and outputs an instruction to the information memory device 432 to output the manipulation information. In response to this, the information memory device 432 outputs previously stored manipulation information to the CPU 433. The CPU 433 transmits the manipulation information to the control terminal 41 together with the identification number of the television terminal 43-1 via the two-way communication device 431.

The manipulation information from the television terminal 43-1 is input to the CPU 414 of the control terminal 41 via the two-way communication device 415, whereby the CPU 414 confirms the identification number of the television terminal 43-1 and stores the manipulation information in the information memory device 412. Since the manipulation information represents the manipulation environment for remotely controlling the television terminal 43-1, the manipulation environment is registered in the control terminal 41 at this point. Once the manipulation environment of the television terminal 43-1 is registered in the control terminal 41, the control terminal 41 no longer requests manipulation information to be output from the television terminal 43-1.

The CPU 414 fetches the appropriate manipulation environment from the information memory device 412, thereby analyzing the manipulation information. The manipulation information is analyzed for preparing the manipulation environment for remotely controlling the network terminal 43.

The CPU 414 instructs the display device 411 to output the display information, whereby a predetermined display of the manipulation environment is displayed on the display panel 64. The predetermined buttons of the control terminal 41 are validated to act as manipulation buttons.

For example, in the case of the manipulation environment for remotely controlling the television terminal 43-1 shown in FIG. 7A, text “TV” is displayed on the display panel 64, the power button 62 and the variable buttons 65, 66, 67 and 68 are validated, and icons representing the functions are displayed on the display panel 64. The manipulation environment for remotely controlling the television terminal 43-1 is thus formed.

After each of the manipulation environments for remotely controlling the network terminals 43 has been registered into the control terminal 41, the network terminals 43-1, 43-2 and 43-3 can be selected by rotating the jog dial 69 so as to be remotely controlled by the control terminal 41.

When, for example, the television terminal 43-1 is selected by manipulating the jog dial 69, the CPU 414 fetches the manipulation information of the television terminal 43-1 from the information memory device 412, thereby analyzing the manipulation information and establishing the manipulation environment for the television terminal 43-1.

In this state, when the user presses a button of the selection device 413, the selection device 413 outputs a manipulation requesting signal corresponding to the pressed button to the CPU 414. The CPU 414 transmits the manipulation requesting signal to the network 42 together with the identification number of the television terminal 43-1 via the two-way communication device 415.

The television terminal 43-1 receives the manipulation requesting signal and the identification number via the two-way communication device 431. The signal is then input to the CPU 433. The CPU 433 confirms that the identification number is that of the television terminal 43-1, and then outputs the manipulation requesting signal to the network terminal controller 434. The network terminal controller 434 performs an operation represented by the manipulation requesting signal.

As a result, a predetermined operation of the television terminal 43-1 which is requested by manipulating the button of the control terminal 41 is performed.

Hereinafter, a specific format of the manipulation information, a process of analyzing the manipulation information by the CPU 414 and a specific format of the manipulation requesting signal will be described.

As previously described, the manipulation information according to the conventional network control system 100 consists of sets of a command and an icon. In this case, the manipulation buttons which perform the same operations to all of the network terminals are not always arranged in the same way for all of the network terminals. Moreover, even when frequently used icon and text such as “channel up”, “channel down”, “volume up” and “volume down” are used, the same icon and text need to be transmitted a great number of times, thereby rendering the system ineffective. In addition, even for the same icon and text such as “channel up”, “channel down”, “volume up” and “volume down”, the shapes of the icons may be different among different network terminals, thereby confusing the user.

In order to overcome the above-described problems, the manipulation environment of the control terminal 41 according to the first example of the present invention includes a plurality of manipulation components which are defined of their types in advance. The manipulation information transmitted from the network terminal 43 to the control terminal 41 has identification numbers for identifying numbers for identifying the manipulation components, types of the manipulation components and additional information.

Hereinafter, the types of the manipulation components according to the first example of the present invention will be described. The types of the manipulation components represent basic types of the manipulation components. All of the manipulation buttons and display contents belong to one type of a manipulation component.

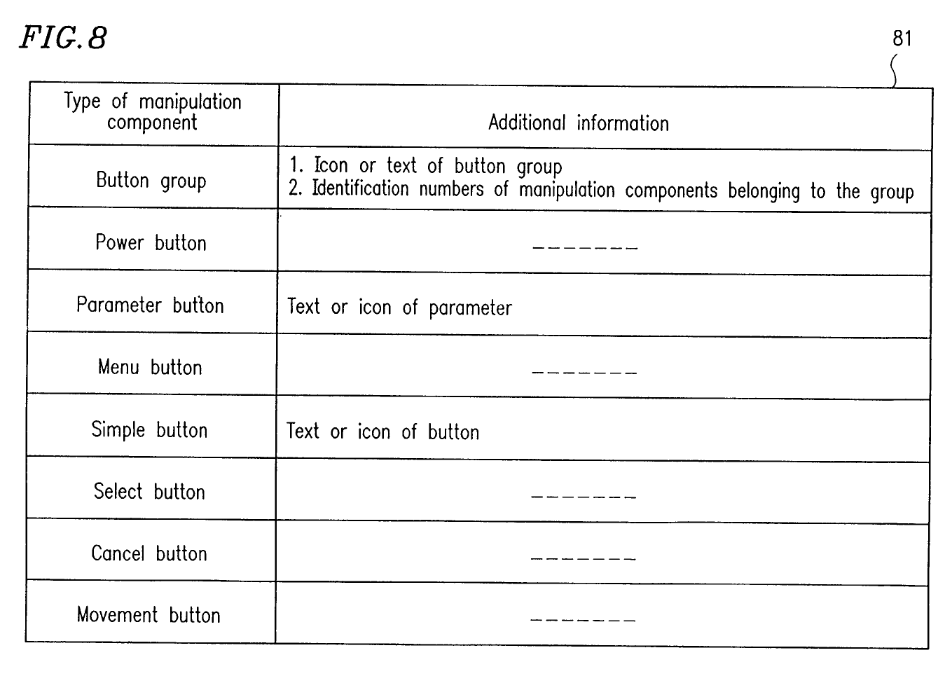

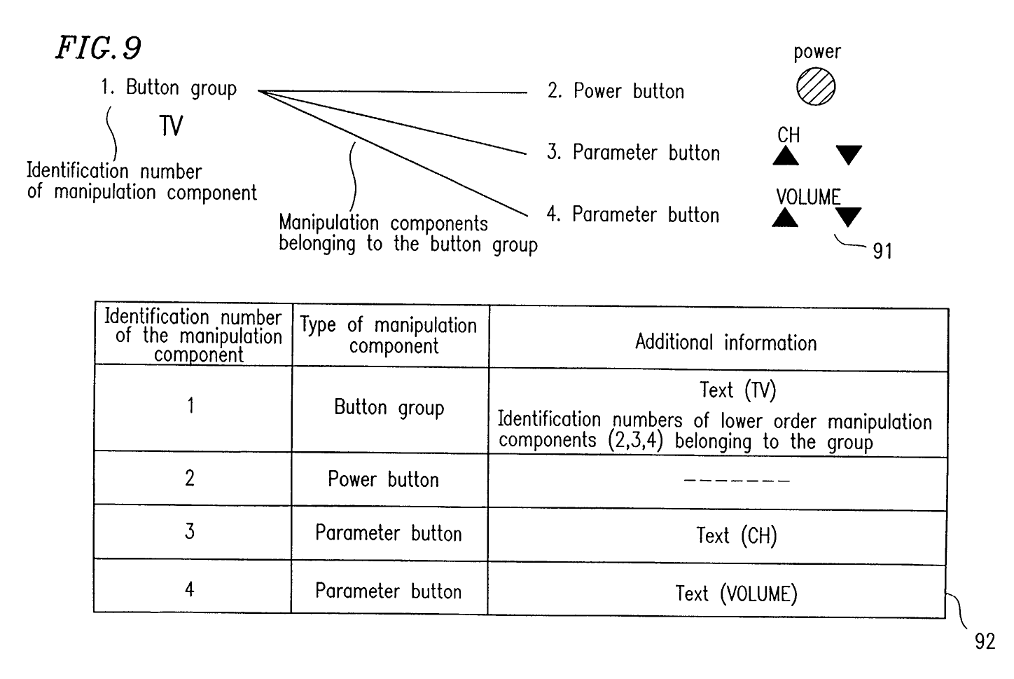

FIG. 8 is a data table 81 showing the types of the manipulation components according to the first example of the present invention.

With reference to FIG. 8, a manipulation component of a type “Button group” is a group of a plurality of lower order manipulation components. As additional information, the “Button group” has text and icons, and identification numbers of the manipulation components belonging to the group. The identification numbers of the manipulation components are used for identifying the manipulation components and are assigned to all of the manipulation components.

A manipulation component of a type “Power button” is the power button 62, having no additional information.

A manipulation component of a type “parameter button” is a set of variable buttons 65 and 66 or a set of variable buttons 67 and 68, having text and/or icon as additional information.

A manipulation component of a type “Menu button” is the menu button 63, having no additional information.

Each of manipulation components of a type “Simple button” is the variable button 65, 66, 67 or 68 assigned with a corresponding function. The “Simple button” has text and/or icon representing the corresponding function as additional information.

A manipulation component of a type “Select button” is the select button 610, having no additional information.

A manipulation component of a type “Cancel” only applies to the cancel button 611, having no additional information.

A manipulation component of a type “Movement button” is the cross-shaped button 612, having no additional information.

The manipulation information according to the first example of the present invention which is transmitted from the network terminal 43 to the control terminal 41 includes at least a part of the information shown in FIG. 8. The control terminal 41 has data and program for decrypting the manipulation information including the identification numbers, the manipulation component types and the additional information. By decrypting the manipulation information transmitted from the network terminal 43, the manipulation environment for remotely controlling the network terminal 43 is established on the control terminal 41.

In the conventional network control system 100, icons for every button need to be transmitted to the control terminal.

According to the first example of the present invention, however, the amount of information to be transmitted is reduced since there are manipulation components with no additional information. Furthermore, each of manipulation components which is common to the plurality of network terminals 43 is already defined and assigned to one manipulation button of the control terminal 41. Therefore, a manipulation environment which may be comfortably manipulated by the user is realized.

For example, in the case of the power button 62, there is no need to transmit an icon thereof as manipulation information since the power button 62 is fixedly prepared on the control terminal 41. Moreover, since the power button 62 is commonly used among the plurality of network terminals 43, it is easy for the user to manipulate the control terminal 41.

Hereinafter, the content of the manipulation information transmitted from each of the television terminal 43-1, the video terminal 43-2 and the image receiver terminal 43-3 in order to establish the manipulation environment shown in FIGS. 7A, 7B and 7C will be described.

FIG. 9 is a diagram showing the manipulation information 92 for establishing the manipulation environment shown in FIG. 7A for remotely controlling the television terminal 43-1 of the network control system 400 according to the first example of the present invention. FIG. 9 further shows the manipulation components 91 represented by the manipulation information 92.

In the manipulation information 92, the manipulation component type “Button group” given an identification number 1 is a main button group of the television terminal 43-1. The “Button group” includes text “TV” as additional information which is displayed on the upper left corner of the display panel 64 of the display device 411. The “Button group” further includes, as the additional information, identification numbers 2, 3 and 4 corresponding to the lower order manipulation components belonging to the group.

The manipulation component type “Power button” given the identification number 2 represents the power button 62, and includes no additional information.

The manipulation component type “Parameter button” given the identification number 3 represents buttons for instructing “channel up” and “channel down”. The “Parameter button” includes text “CH” as the additional information. An upwardly pointing arrow icon and a downwardly pointing arrow icon are registered in the control terminal 41 in advance as additional information of the “Parameter Button”. The upwardly pointing arrow icon and the downwardly pointing arrow icon are displayed with the text “CH” as shown in FIG. 7A. The variable buttons 65 and 66 below the icons are used for instructing “channel up” and “channel down”.

The manipulation component type “Parameter button” given the identification number 4 represents buttons for instructing “volume up” and “volume down”. The “Parameter button” includes text “VOLUME” as the additional information. An upwardly pointing arrow icon and a downwardly pointing arrow icon are registered in the control terminal 41 in advance as additional information of the “Parameter Button”. The upwardly pointing arrow icon and the downwardly pointing arrow icon are displayed with the text “VOLUME” as shown in FIG. 7A. The variable buttons 67 and 68 below the icons are used for instructing “volume up” and “volume down”.

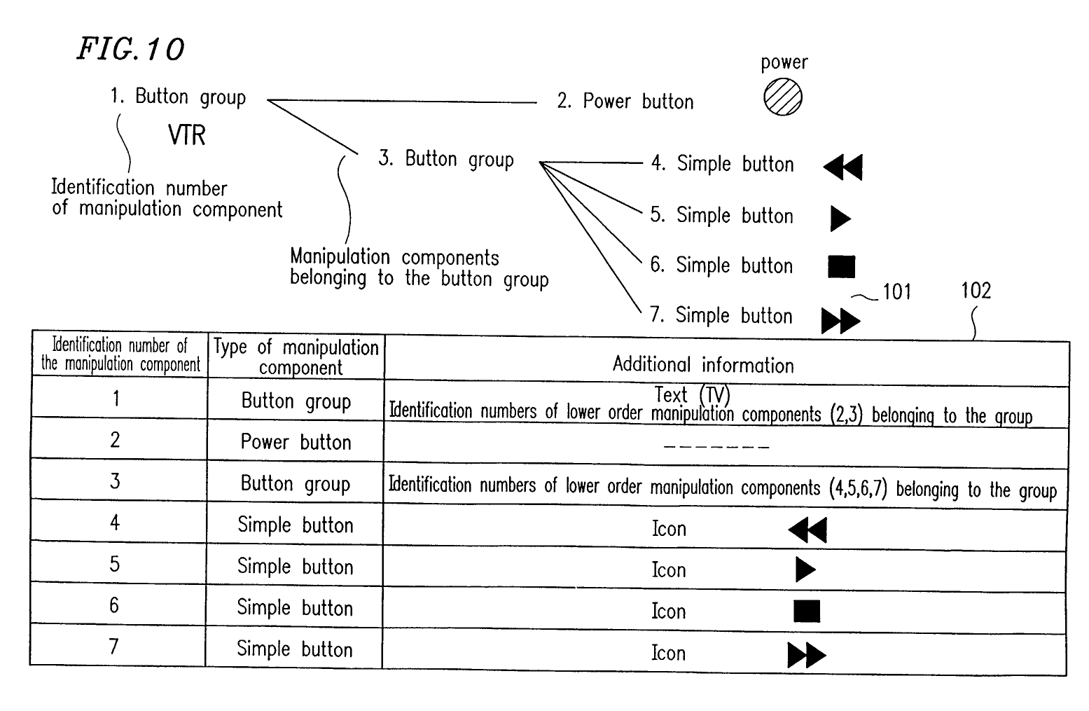

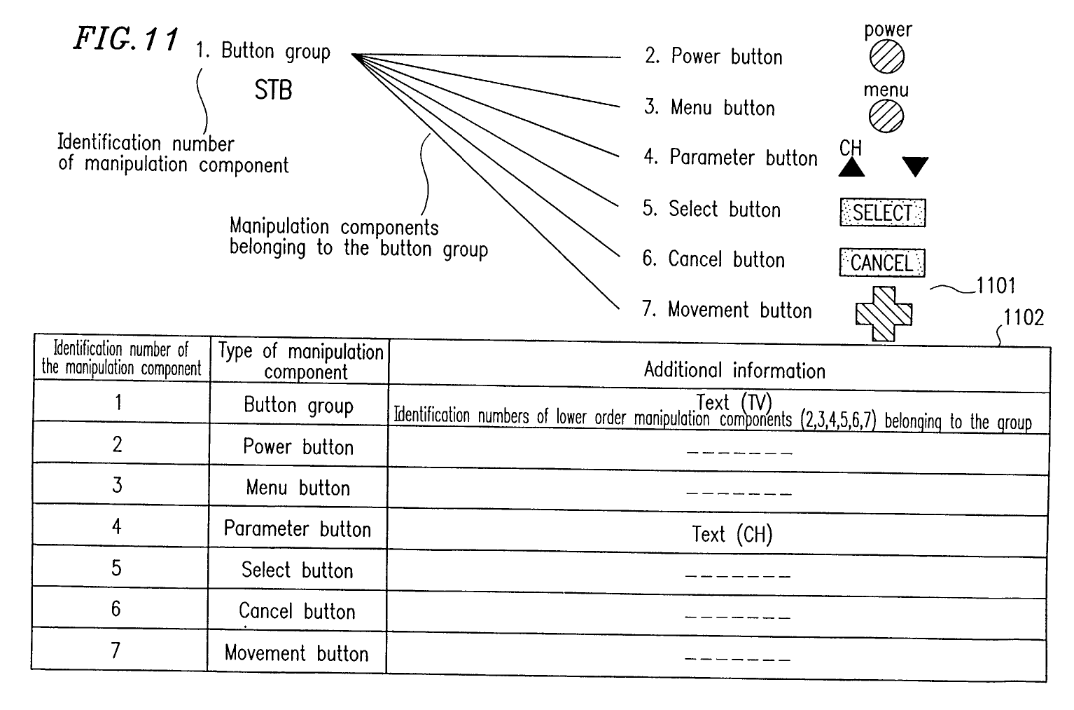

FIG. 10 is a diagram showing the manipulation information 102 for establishing the manipulation environment shown in FIG. 7B for remotely controlling the video terminal 43-2 of the network control system 400 according to the first example of the present invention. FIG. 10 further shows the manipulation components 101 represented by the manipulation information 102.

In the manipulation information 102, the manipulation component type “Button group” given an identification number 1 is a main button group of the video terminal 43-2. The “Button group” includes text “VTR” as additional information which is displayed on the upper left corner of the display panel 64 of the display device 411. The “Button group” further includes, as the additional information, identification numbers 2 and 3 corresponding to the lower order manipulation components belonging to the group.

The manipulation component type “Power button” given the identification number 2 represents the power button 62, and includes no additional information.

The manipulation component type “Button group” given the identification number 3 is a group of lower order manipulation components for controlling the video terminal 43-2. The “Button group” further includes identification numbers 4, 5, 6 and 7 corresponding to the lower order manipulation components belonging to the group.

The manipulation component type “Simple button” given the identification number 4 represents a button for instructing “rewind” and includes an icon representing “rewind”. The icon is displayed on the display panel 64 as shown in FIG. 7B. The variable button 65 below the icon is used for instructing “rewind”.

Similarly, the manipulation component types “Simple button” given the identification numbers 5, 6 and 7 represent buttons for instructing “play”, “stop” and “fast forward”, respectively, and includes icons representing “play”, “stop” and “fast forward”, respectively. The icons are displayed on the display panel 64 as shown in FIG. 7B. The variable buttons 66, 67 and 68 below the icons are used for instructing “play”, “stop” and “fast forward”, respectively.

Since the manipulation components given the identification numbers 4, 5, 6 and 7 belong to the higher order manipulation component type given the identification number 3, they are treated as a group in the manipulation environment 102. Accordingly, even when the control terminal 41 has more than four variable buttons, the manipulation components given the identification numbers 4, 5, 6 and 7 are treated as one group and are sequentially and collectively assigned to the plurality of variable buttons so that the manipulation components are arranged close to each other.

FIG. 11 is a diagram showing the manipulation information 1102 for establishing the manipulation environment shown in FIG. 7C for remotely controlling the image receiver terminal 43-3 in the network control system 400 according to the first example of the present invention. FIG. 11 further shows the manipulation components 1101 represented by the manipulation information 1102.

In the manipulation information 1102, the manipulation component type “Button group” given an identification number 1 is a main button group of the image receiver terminal 43-3. The “Button group” includes text “STB” as additional information which is displayed on the upper left corner of the display panel 64 of the display device 411. The “Button group” further includes, as the additional information, identification numbers 2, 3, 4, 5, 6 and 7 corresponding to the lower order manipulation components belonging to the group.

The manipulation component type “Power button” given the identification number 2 represents the power button 62, and includes no additional information.

The manipulation component type “Parameter button” given the identification number 3 represents the menu button 63.

The manipulation component type “Parameter button” given the identification number 4 represents buttons for instructing “channel up” and “channel down”. The “Parameter button” includes text “CH” as additional information. An upwardly pointing arrow icon and a downwardly pointing arrow icon are registered in the control terminal 41 in advance as additional information of the “Parameter Button”. The upwardly pointing arrow icon and the downwardly pointing arrow icon are displayed with the text “CH” as shown in FIG. 7C. The variable buttons 65 and 66 below the icons are used for instructing “channel up” and “channel down”.

The manipulation component type “Select” given the identification number 5 represents the select button 610.

The manipulation component type “Cancel” given the identification number 6 represents the cancel button 611.

The manipulation component type “Movement button” given the identification number 7 represents the cross-shaped button 612.

The above-described manipulation information is transmitted from each of the network terminals 43 to the control terminal 41. Based on this manipulation information, the manipulation environments for remotely controlling the network terminals are registered in the control terminal 41.

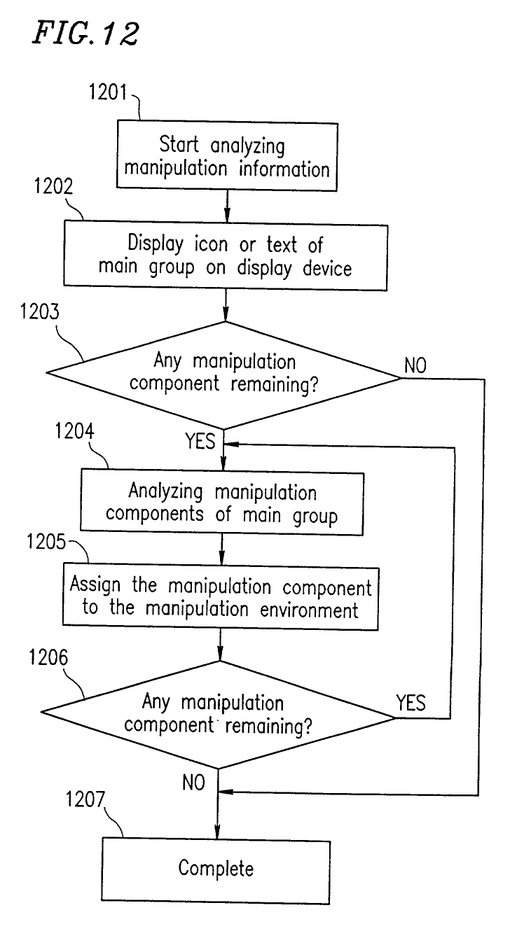

Hereinafter, analysis of the manipulation information performed by the control terminal 41 will be described with reference to FIG. 12.

FIG. 12 is a flow diagram showing operations performed by the control terminal 41 of the network control system 400 according to the first example of the present invention.

Once the CPU 414 of the control terminal 41 receives the manipulation information from the network terminal 43, the CPU 414 starts analyzing the manipulation information (Step 1201). The CPU 414 selects and analyzes a manipulation component corresponding to the main button group from the manipulation information, thereby reading and displaying an icon and/or text of the manipulation component on the upper left corner of the display panel 64 (Step 1202). Thereafter, when the manipulation information still includes an unprocessed manipulation component (Step 1203, YES), the CPU 414 analyzes the unprocessed manipulation component (Step 1204) and assigns this manipulation component to the control terminal 41 (Step 1205). Then, the CPU 414 confirms whether or not the manipulation information includes an unprocessed manipulation component (Step 1206). When the manipulation information includes an unprocessed manipulation component (Step 1206, YES), the process returns to Step 1204. When the manipulation information does not include an unprocessed manipulation component (Step 1206, NO), analysis of the manipulation information is completed.

For example, when the control terminal 41 receives the manipulation information for establishing the manipulation environment of the television terminal 43-1 shown in FIG. 9, the manipulation information is analyzed according to the following steps.

The text “TV” is read from the additional information of the manipulation component type corresponding to the main button group given the identification number 1, and is displayed on the upper left corner of the display panel 64.

The identification numbers 2, 3 and 4 are read from the additional information of the manipulation component of the identification number 1, and the manipulation components given the identification numbers 2, 3 and 4 are analyzed.

The manipulation component type of the identification number 2 is the power button 62. Thus the power button 62 of the control terminal 41 is validated.

The manipulation component type of the identification number 3 is “Parameter button”. Thus, text “CH” is read from the additional information of the manipulation component. The text “CH” is combined with the upwardly pointing arrow icon and the downwardly pointing arrow icon which are registered in the control terminal 41 in advance, so as to be displayed on the display panel 64. The icons are sequentially displayed from the left hand side of the display panel so that “channel up” and “channel down” are sequentially assigned to the leftmost variable button 65 and the adjacent variable button 66.

The manipulation component type of the identification number 4 is “Parameter button”. Thus, text “VOLUME” is read from the additional information of the manipulation component. The text “VOLUME” is combined with the upwardly pointing arrow icon and the downwardly pointing arrow icon which are registered in the control terminal 41 in advance, so as to be displayed on the display panel 64. The icons are sequentially displayed on the right side of the already displayed icons so that “volume up” and “volume down” are sequentially assigned to the variable buttons 67 and 68.

Once all of the manipulation components included in the manipulation information are analyzed, the manipulation environment for remotely controlling the television terminal 43-1 is established on the control terminal 41. In a similar manner, the manipulation environments for remotely controlling the video terminal 43-2 and the image receiver terminal 43-3 may be established.

Hereinafter, a process for remotely controlling the network terminal 43 by the control terminal 41 will be described.

First, a manipulation requesting signal is transmitted from the control terminal 41 to the network terminal 43 which is to be remotely controlled. The manipulation requesting signal includes identification numbers and several additional information. For example, when a command indicating “power on” is to be transmitted to the television terminal 43-1, a manipulation requesting signal including the identification number of the television terminal 43-1 and the identification number 2 corresponding to the power button 62 is transmitted to the television terminal 43-1. In the case of the power button 62, no additional information is included in the manipulation requesting signal.

The additional information of the manipulation requesting signal is generated only for manipulation component types “Parameter button” and “Movement button”. The additional information is used for specifying the selected manipulation component.

When the user presses the variable button 65 for commanding “channel up” to the television terminal 43-1, the control terminal 41 transmits additional information “up” which is given the identification number 3. When the television terminal 43-1 receives the additional information “up” with the identification number 3, channel up operation is performed.

Moreover, when the user who is remotely controlling the image receiver terminal 43-3 selects a left direction on the cross-shaped button 612, the control terminal 41 transmits the identification number 7 and additional information “Left” to the image receiver terminal 43-3. When the image receiver terminal 43-3 receives the identification number 7 and the additional information “Left”, an operation selected by moving the cursor to the left direction by the cross-shaped button 612 is performed.

The effect of the above-described network control system 400 according to the first example of the present invention can be summarized as follows.

According to the conventional network control system 100, in order to remotely control the network terminal, icons for all of the manipulation buttons need to be transmitted from the network terminal to the control terminal.

On the other hand, according to the first example of the present invention, for some of the manipulation components, only the types of the manipulation components need to be transmitted instead of the manipulation components. For those manipulation components, it is not necessary to transmit icons corresponding thereto, thereby reducing the amount of the manipulation information to be transmitted.

For example, in the conventional network control system 100, when one manipulation button corresponds to bit map of 16×16 monochromatic icon, a total of 256 bits needs to be transmitted. In the case where only the types of the manipulation components are to be transmitted to the control terminal 41 as in the network control system 400 according to the first example of the present invention, even if there is 256 manipulation components to be transmitted, only an 8 bit signal needs to be transmitted for one manipulation button. Thus, the amount of manipulation information is reduced.

Since some of the manipulation components are fixedly set in the control terminal 41, usability of the control terminal 41 for the user is enhanced. For example, the power button 62 which performs a same operation to each network terminal 43 is provided on the control terminal 41. Therefore, the user can use only one power button 62 to turn on or turn off the power of any of the network terminals 43. Alternatively, a manipulation button with its corresponding icon may be used instead of the power button 62.

Moreover, the manipulation information is transmitted from the network terminal 43 to the control terminal 41, so that the manipulation information is analyzed by the control terminal 41, whereby the user is provided with the manipulation environment. Therefore, even when a new network terminal 43 is connected to the network 42, a manipulation environment for remotely controlling the new network terminal 43 is automatically established on the control terminal 41. Furthermore, since the control terminal 41 includes part of manipulation components for each of the manipulation component types in advance, the amount of the manipulation information transmitted from the network terminal 43 is reduced.

According to the first example of the present invention, the television terminal 43-1, the video terminal 43-2 and the image receiver terminal 43-3 are illustrated as the network terminals 43. The present invention, however, is applicable to other types of network terminals.

According to the first example of the present invention, a radio infrared network is used as the network 42. The present invention, however, is equally applicable when a cable network is used.

Furthermore, according to the first example of the present invention, the control terminal 41 performs polling so as to confirm whether or not there is a new network terminal 43. When there is a new network terminal 43, the control terminal 41 requests manipulation information to be transmitted from the new network terminal 41, so as to download the manipulation information of the new network terminal 41. The present invention, however, is not limited thereto, and the manipulation information may be downloaded according to any kind of method. For example, the manipulation information may be spontaneously transmitted from the network terminal 43 to the control terminal 41 when the power of the network terminal 43 is turned on, or when the network terminal 43 connects to the network 42.

According to the first example of the present invention, buttons are used as manipulation elements. The present invention, however, is not limited thereto, and is equally applicable when other elements (e.g., speech recognition elements or voice guiding elements) are used for manipulation.

### EXAMPLE 2

Hereinafter, a network control system 1300 including a control terminal 1301 and a network terminal 1303 according to a second example of the present invention will be described.

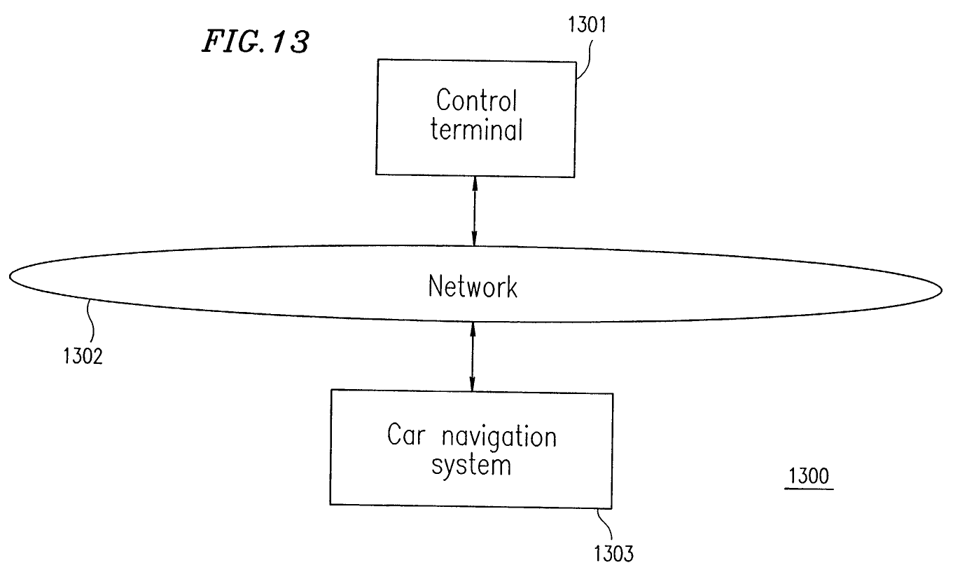

FIG. 13 is a schematic diagram showing the network control system 1300 according to the second example of the present invention. The network control system 1300 includes the control terminal 1301, a network 1302 and a car navigation system as the network terminal 1303.

According to the second example of the present invention, the network 1302 is a cable network. The control terminal 1301 remotely controls the car navigation system 1303 via the cable network 1302.

The control terminal 1301 and the car navigation system 1303 function in substantially the same manner as the control terminal 41 and the network terminal 43 shown in FIG. 4A.

The manner of downloading manipulation information, structure of the manipulation information and the manner of transmitting the manipulation requesting signal are basically the same as those according to the first example of the present invention.

Specifically, manipulation information is downloaded from the car navigation system 1303 to the control terminal 1301 so that a manipulation environment for remotely controlling the car navigation system 1303 is established in the control terminal 1301.

According to the second example, the manipulation information is downloaded when the car navigation system 1303 connects to the network 1302. In other words, manipulation information is transmitted from the car navigation system 1303 to the control terminal 1301 when the car navigation system 1303 connects to the network 1302 as a new network terminal.

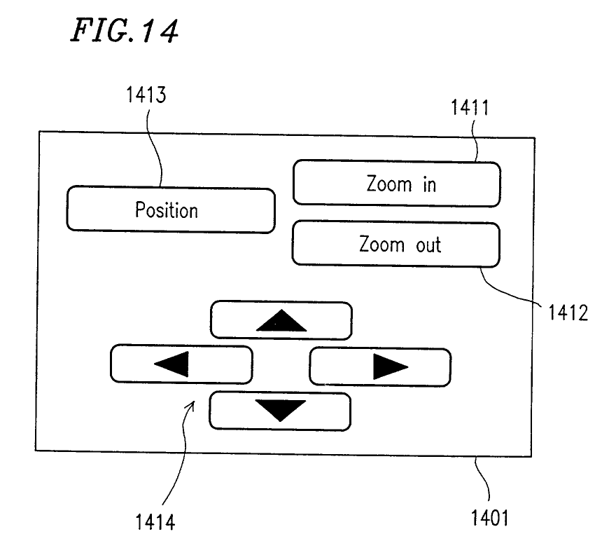

FIG. 14 is a plan view showing the manipulation environment for remotely controlling the car navigation system 1303 established on the control terminal 1301.

A display screen 1401 is displayed on the display panel 64 of the display device 411 of the control terminal 1301. The display screen 1401 represents the manipulation environment for remotely controlling the car navigation system 1303, including a “Zoom in” (enlargement) button 1411, a “Zoom out” (contraction) button 1412, a position button 1413 for displaying the present position and a cross-shaped button 1414 for moving a cursor.

The “Zoom in” button 1411, the “Zoom out” button 1412, the “position” button 1413 and the cross-shaped button 1414 (including left, right, up and down buttons) are displayed on the display panel 64 of the display device 411 of the control terminal 1301. The display panel 64 is a touch panel display. When the user touches one of these manipulation buttons, a manipulation requesting signal corresponding to the touched button is transmitted from the control terminal 1301 to the car navigation system 1303. In response to this manipulation requesting signal, the car navigation system 1303 performs an operation corresponding to the transmitted manipulation requesting signal.

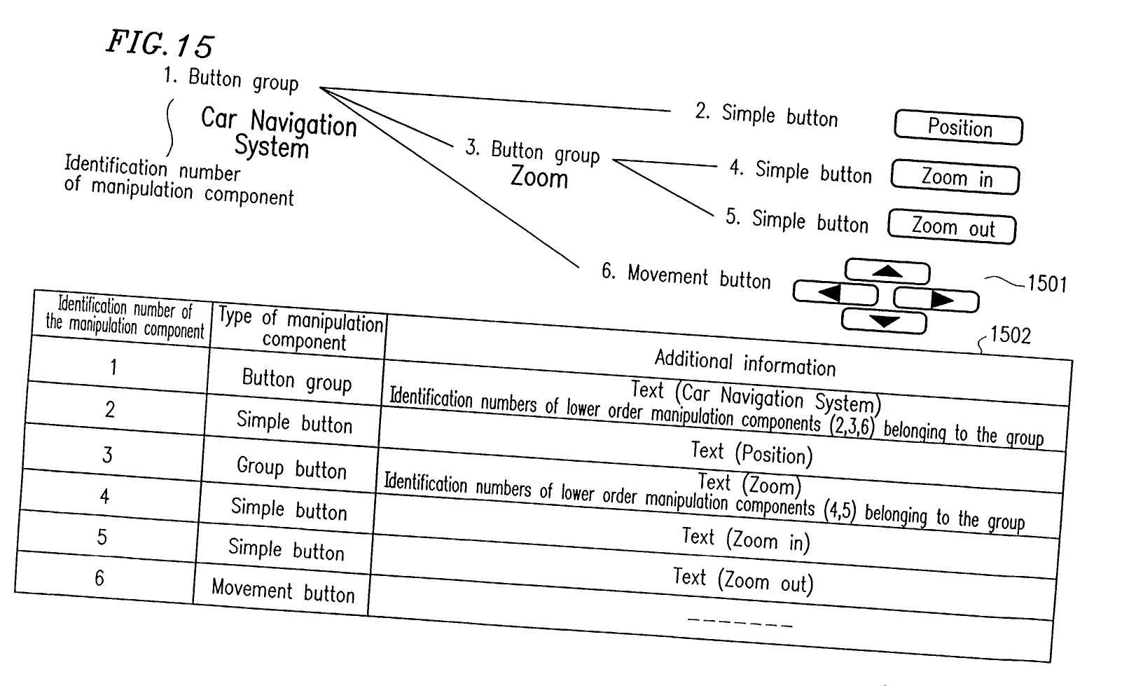

FIG. 15 is a diagram showing the manipulation information 1502 for establishing the manipulation environment shown in FIG. 14 for remotely controlling the car navigation system 1303 in the network control system 1300 according to the second example of the present invention. FIG. 15 further shows the manipulation components 1501 represented by the manipulation information 1502.

In the manipulation information 1502, the manipulation component type “Button group” given an identification number 1 is a main button group of the car navigation system 1303. The “Button group” includes text “Car navigation” as additional information which is used as information for the user to read. The “Button group” further includes, as the additional information, the identification numbers 2, 3 and 6 corresponding to the lower order manipulation components belonging to the group.

The manipulation component type “Simple button” given the identification number 2 represents the “Position” button 1413 and has text “Position” as additional information.

The manipulation component type “Button group” given the identification number 3 represents the “Zoom in” button 1411 and the “Zoom out” button 1412, and has text “Zoom” as additional information. The “Button group” further includes identification numbers 4 and 5.

The manipulation component type “Simple button” given the identification numbers 4 and 5 represent the “Zoom in” button 1411 and the “Zoom out” button 1412, respectively. Each of the “Simple button” has text “Zoom in” and “Zoom out”, respectively.

The manipulation component type “Movement button” given the identification number 6 represents the cross-shaped button 1414.

The above-described manipulation information 1502 is transmitted from the car navigation system 1303 to the control terminal 1301. Based on this manipulation information 1502, the manipulation environment for remotely controlling the car navigation system 1303 is registered in the control terminal 1301.

According to the second example of the present invention, the cross-shaped button 1414 is not fixedly provided as the cross-shaped button 612 is in the first example of the present invention. Bit map and a position of each of the buttons of the cross-shaped button 1414 are stored in the control terminal 1301. When the cross-shaped button 1414 is required in the manipulation environment as a result of the analysis of the manipulation information, the cross-shaped button 1414 is displayed on the display panel 64 of the display device 411 based on the bit maps and the positions of the buttons.

The “Zoom in” button 1411, the “Zoom out” button 1412 belong to one button group. The control terminal 1301 identifies each of the buttons 1411 and 1412 and collectively displays the buttons 1411 and 1412 on the display panel 64 of the display device 411.

In the conventional network control system 100, the buttons are displayed without regard to the relationship among the buttons. Therefore, related buttons are not always collectively arranged so as to be close to each other.

According to the second example of the present invention, related buttons are defined as one group. Accordingly, the buttons are collectively arranged so as to be close to each other. Thus, usability of the control terminal 1301 for the user is enhanced since related buttons such as the “Zoom in” button 1411 and the “Zoom out” button 1412 are easy for the user to manipulate when they are displayed close to each other.

Moreover, a plurality of button groups may be defined such that each of the button groups has a display screen assigned thereto. By doing so, the button groups are selectively displayed by switching the display screens on the display panel 64, thereby enabling a large number of manipulation components to be displayed.

Hereinafter, the above-described display method will be described in detail.

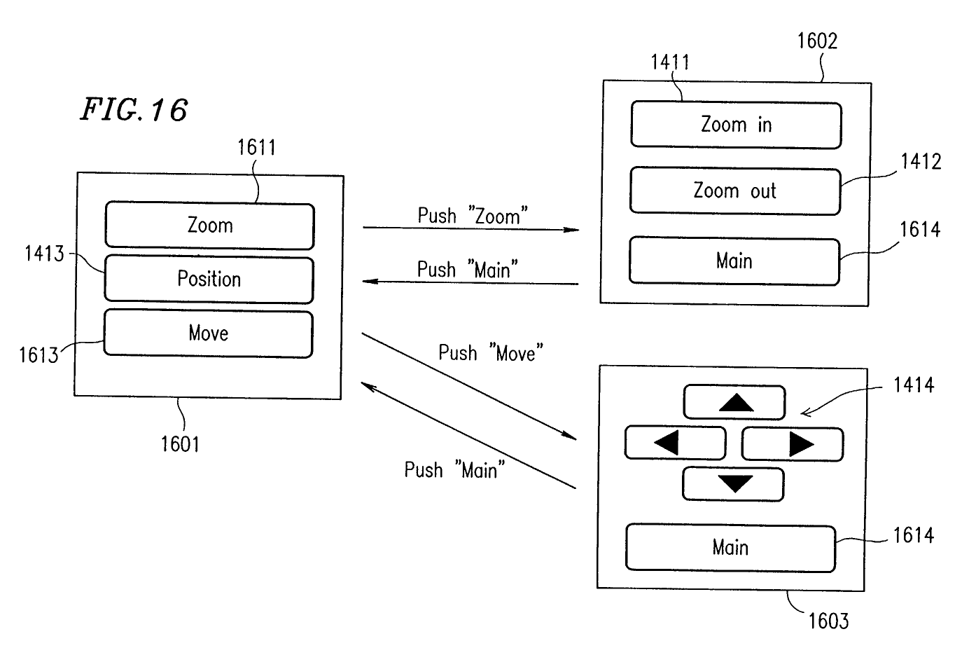

FIG. 16 is a plan view showing a plurality of display screens 1601, 1602 and 1603. It is assumed that the display panel 64 is so small that the “Zoom in” button 1411, the “Zoom out” button 1412 and the cross-shaped button 1414 cannot be displayed at once. The “Zoom in” button 1411 and the “Zoom out” button 1412 belong to one button group, and each of the buttons included in the cross-shaped button 1414 belong to the other button group.

The display screen 1601 is the main screen of the manipulation environment for remotely controlling the car navigation system 1303. In the display screen 1601, a “Zoom” button 1611, the “Position” button 1413 and a “Move” button 1613 are displayed. By selectively touching the “Zoom” button 1611 or the “Move” button 1613, the display screen 1601 switches to the display screen 1602 or 1603. The “Position” button 1413, is not used for switching the display screen but is used to directly instruct function corresponding to the “Position” button 1413.

When the user touches the “Zoom” button 1611 when the main display screen 1601 is displayed on the display screen 64, the display screen of the display panel 64 changes to the display screen 1602. The display screen 1602 includes the “Zoom in” button 1411, the “Zoom out” button 1412 and a “Main” button 1614 for returning to the main display screen 1601.

When the user touches the “Move” button 1613 when the main display 1601 is displayed on the display panel 64, the display screen of the display panel 64 changes to the display screen 1603. The display screen 1603 includes the cross-shaped button 1414 and the “Main” button 1614 for returning to the main display screen 1601.

According to this method, the buttons are divided into related groups. Therefore, even in the case where the display panel 64 of the control terminal 1301 is so small that the manipulation environment cannot be displayed on the display panel 64 at once, the related buttons included in the same group are displayed on the same display screen. Thus, the user can comfortably use the control terminal 1301.

In the conventional network control system 100, such grouping of the manipulation buttons is not conducted. Therefore, the manipulation buttons may be separately displayed on a plurality of display screens, which is uncomfortable for the user to use the manipulation buttons.

Hereinafter, the above-described disadvantage of the conventional network control system 100 will be described.

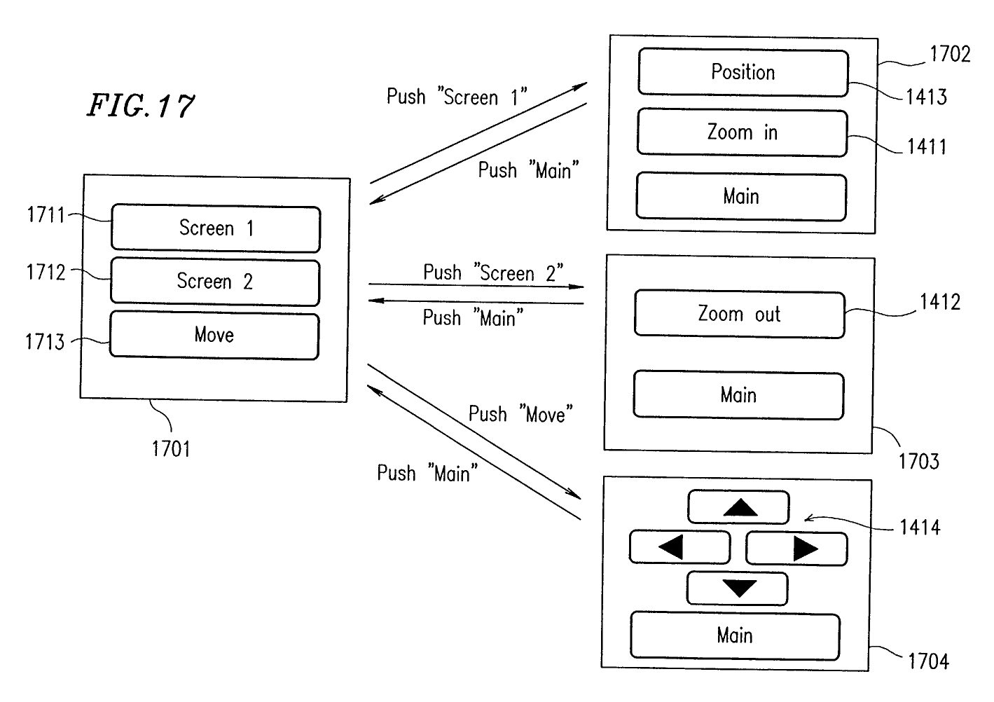

FIG. 17 is a plan view showing a plurality of display screens 1701, 1702 and 1703. The display screen 1701 is a main screen in which a “Screen 1” button 1711, a “Screen-2” button 1712 and a “Move” button 1713 are displayed. By selectively touching the “Screen 1” button 1711, the “Screen 2” button 1712 or the “Move” button 1713, the display screen is switched among the display screens 1702, 1703 and 1704.

As can be appreciated from the display screens 1702, 1703 and 1704 shown in FIG. 17, the related “Zoom in” and “Zoom out” buttons 1411 and 1412 are displayed separately on the display screens 1702 and 1703. Therefore, in order to alternately use the “Zoom in” and “Zoom out” buttons 1411 and 1412, the user should proceed the steps of switching the display screens in the order of “1701→1702→1701→1703” or “1701→1703→1701→1702”, which renders the manipulation complicated.

According to the second example of the present invention, the manipulation information is transmitted from the network terminal, i.e., the car navigation system 1303, to the control terminal 1301. The transmitted manipulation information is analyzed by the control terminal 1301, thereby establishing the manipulation environment for the user. Since related manipulation buttons are grouped into one button group, the related buttons are collectively displayed, thereby enhancing the usability of the control terminal 1301 for the user.

According to the second example of the present invention, a car navigation system is illustrated as the network terminal 1303. The present invention, however, is not limited thereto and is equally applicable to other network terminals.

Moreover, according to the second example of the present invention, a cable network is used as the network 1302. The present invention, however, is equally applicable when a radio network is used as the network 1302.

Furthermore, according to the second example of the present invention, the manipulation information is downloaded from the network terminal 1303 to the control terminal 1301 when the network terminal 1303 connects to the control terminal 1301. The present invention, however, is not limited thereto, and the manipulation information may be downloaded according to any kind of method.

According to the second example of the present invention, buttons are used as manipulation elements. The present invention, however, is not limited thereto and is equally applicable when other elements (e.g., speech recognition elements or voice guiding elements) are used for manipulation.

### EXAMPLE 3

Hereinafter, a network control system 1800 including a control terminal 1801 and network terminals 1803, 1804 and 1805 according to a third example of the present invention will be described.

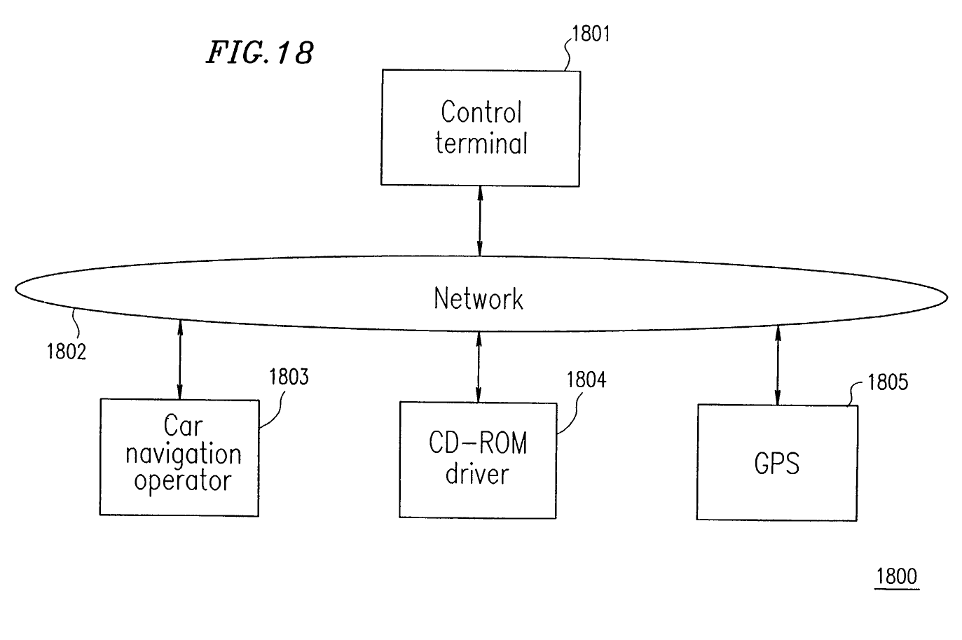

FIG. 18 is a block diagram schematically showing the network control system 1800 according to the third example of the present invention. The network control system 1800 includes a control terminal 1801, a network 1802, a car navigation operator 1803, a CD-ROM driver 1804 and a GPS (Global Positioning System) 1805. According to the third example of the present invention, the car navigation operator 1803, the CD-ROM driver 1804 and the GPS 1805 are the network terminals.

According to the third example of the present invention, manipulation information is transmitted from the network terminals to the control terminal 1801 in substantially same manner as in the first example of the present invention. The transmitted manipulation information is analyzed by the control terminal 1801, thereby establishing a manipulation environment for remotely controlling the network terminals 1803, 1804 and 1805. The structure of the control terminal 1801, the structures of the network terminals 1803, 1804 and 1805, the types of the manipulation components are substantially the same as those according to the previously described examples of the present invention.

According to the third example of the present invention, an application is not realized only by the car navigation operator 1803. The application is realized when the network terminals (i.e., the car navigation operator 1803, the CD-ROM driver 1804 and the GPS 1805) are combined.

Specifically, the car navigation operator 1803 receives data indicating a map from the CD-ROM driver 1804 via the network 1802 and receives location data from the GPS 1805, thereby performing an operation.

In the network control system 1800 according to the third example of the present invention, a manipulation environment for remotely controlling the above-described application is automatically established in the control terminal 1801 when the car navigation operator 1803, the CD-ROM driver 1804 and the GPS 1805 are connected to each other.

One network terminal receives function information from other network terminals via the network 1802, and identifies what kind of application can be provided when combined with the other network terminals. Then, the identified application is transmitted to the control terminal 1801. Herein, the term “function information” refers to information indicating a function of each network terminal.

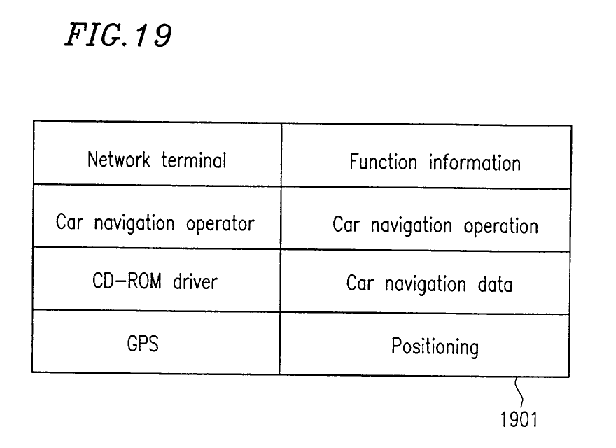

FIG. 19 is a table 1901 showing function information which are exchanged among the network terminals 1803, 1804 and 1805.

The car navigation operator 1803 transmits function information “car navigation operation”. The CD-ROM driver 1804 transmits function information “car navigation data”. The GPS 1805 transmits function information “positioning”.

The above-mentioned function information is exchanged among the network terminals. Based on the function information from other network terminals, each network terminal determines whether or not its application can be realized.

In order to realize the car navigation application, the car navigation operator 1803 requires a network terminal having a function of “car navigation data” and a network terminal having a function of “positioning”. The car navigation operator 1803 receives the function information “car navigation data” from the CD-ROM driver 1804 and receives the function information “positioning” from the GPS 1805, thereby determining that the car navigation application can be realized.

Hereinafter, the way the car navigation operator 1803 determines that the car navigation application can be realized will be described in detail.

It is assumed that now the control terminal 1801, the CD-ROM driver 1804 and the GPS 1805 are connected to the network 1802.

When the car navigation operator 1803 connects to the network 1802, the car navigation operator 1803 transmits a function information transmission request to each network terminal via the network 1802. Each network terminal which has received the function information transmission request transmits function information to the car navigation operator 1803.

Specifically, the CD-ROM driver 1804 transmits the function information “car navigation data” and the GPS 1805 transmits the function information “positioning” to the car navigation operator 1803. By receiving the above-mentioned function information, the car navigation operator 1803 determines that the car navigation application can be provided.

Once the car navigation operator 1803 determines that the car navigation application can be realized, the car navigation operator 1803 transmits manipulation information to the control terminal 1801. The control terminal 1801 analyzes the transmitted manipulation information, thereby establishing a manipulation environment for remotely controlling the car navigation system.

A format of the manipulation information, process for establishing the manipulation environment in the control terminal 1801 and the like are substantially the same as those described in the second example of the present invention.

In the above-described exemplary operation, the car navigation operator 1803 is connected to the network 1802 as a new network terminal. When the CD-ROM driver 1804 or the GPS 1805 is connected to the network 1802 as a new network terminal, function information thereof is spontaneously transmitted to the car navigation operator 1803. Accordingly, the car navigation operator 1803 connected to the network 1802 receives the function information, thereby determining that the car navigation application can be realized.

According to the above-described operation, an application of a new network terminal can be automatically controlled by the control terminal by simply connecting the network terminal to the network.

According to the third example of the present invention, a car navigation system is illustrated. The present invention, however, is not limited thereto, and is applicable to any network control system for providing an application.

### EXAMPLE 4

Hereinafter, a network control system 2000 including a control terminal 2001 and network terminals 2002, 2004, 2005 and 2006 according to a fourth example of the present invention will be described.

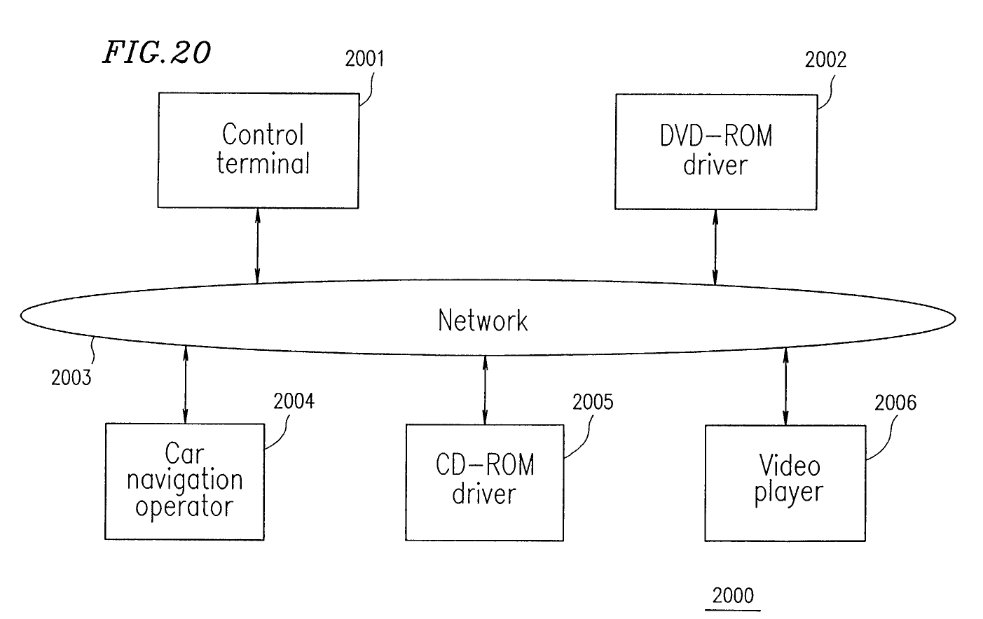

FIG. 20 is a block diagram schematically showing the network control system 2000 according to the fourth example of the present invention. The network control system 2000 includes the control terminal 2001, a DVD-ROM driver 2002, a network 2003, a car navigation operator 2004, a CD-ROM driver 2005 and a video player 2006.

According to the fourth example of the present invention, in substantially the same manner as in the previously described examples, manipulation information is transmitted from the network terminals to the control terminal 2001 and the control terminal 2001 analyzes the manipulation information, thereby establishing a manipulation environment for remotely controlling the network terminals 2002, 2004, 2005 and 2006. The structure of the control terminal 2001, the structures of the network terminals 2002, 2004, 2005 and 2006 and types of the manipulation components are substantially the same as those described in the previous examples.

According to the fourth example of the present invention, in the same manner as in the third example of the present invention, an application is provided by combining a plurality of network terminals 2002, 2004, 2005 and 2006. Process for exchanging function information among the network terminals 2002, 2004, 2005 and 2006, and determining an application provided by the network terminals-and a structure of the function information are substantially the same as those in the third example of the present invention.

According to the fourth example of the present invention, when states of the network terminals 2002, 2004, 2005 and 2006 change, an application which can be realized according to network terminals 2002, 2004, 2005 and 2006, dynamically changes as well.

According to the fourth example of the present invention, an application is not realized only by the car navigation operator 2004, but when it cooperates with the CD-ROM driver 2005. The car navigation operator 2004 receives car navigation data from the CD-ROM driver 2005 only when a disk containing a database of the car navigation system is set in the CD-ROM driver 2005, whereby an application is realized by the car navigation operator 2004.

The video player 2006 receives video data from the DVD-ROM driver 2002 or the CD-ROM driver 2005 when a disk containing video data is set in the DVD-ROM driver 2002 or the CD-ROM driver 2005, thereby realizing an application for playing a video.

Thus, according to the fourth example of the present invention, the application to be realized changes when a disk in the DVD-ROM driver 2002 or the CD-ROM driver 2005 is exchanged.

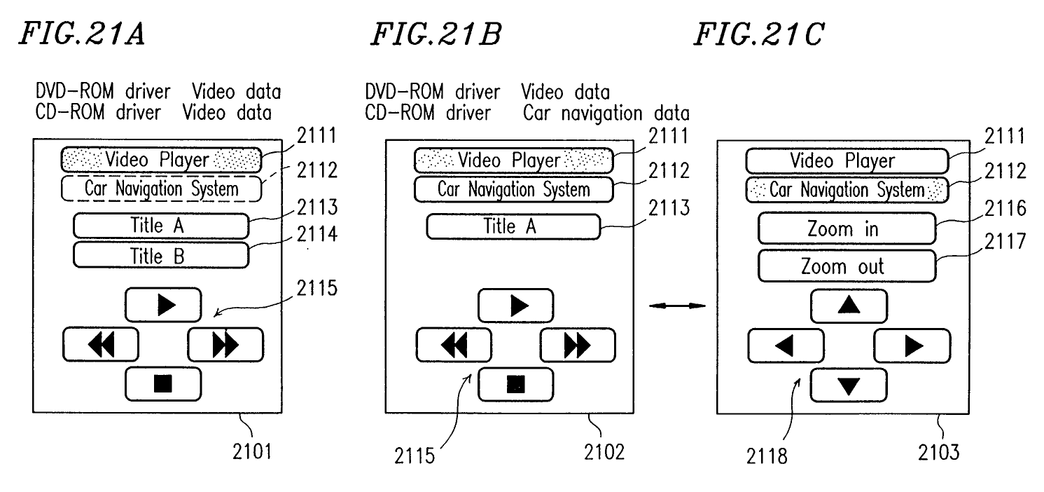

Hereinafter, manipulation environments according to the fourth example of the present invention will be described with reference to FIGS. 21A, 21B and 21C.

FIGS. 21A, 21B and 21C are plan views showing display screens 2101, 2102 and 2103, respectively, which are displayed on a display panel 64 of a display device 411 of the control terminal 2001. The display screens 2101 and 2102 are manipulation environments used for remotely controlling the video player 2006. The display screen 2103 is a manipulation environment used for remotely controlling the car navigation operator 2004.

The display screen 2101 is used when both of the DVD-ROM driver 2002 and the CD-ROM driver 2005 include video data. A “Video Player” button 2111 and a “Car Navigation System” button 2112 are used for selecting the application. In FIGS. 21A, 21B and 21C, shaded button corresponds to a presently selected application.

When both of the DVD-ROM driver 2002 and the CD-ROM driver 2005 include video data, the car navigation operator 2004 cannot realize the application of the car navigation system. Therefore, in FIG. 21A, the “Car Navigation System” button 2112 of the display screen 2101 is drawn with a broken line, which indicates that the display screen does not change to the display screen 2103 for remotely controlling the car navigation system even when the “Car Navigation System” button 2112 is selected.

The manipulation environment shown in FIG. 21A for remotely controlling the video player 2006 includes “Title A” and “Title B” buttons 2113 and 2114 for selecting video data, and a group of buttons 2115 including play, rewind, fast forward and stop buttons.

Since the video player 2006 operates by using a database of either one of the DVD-ROM driver 2002 or the CD-ROM driver 2005, the “Title A” and “Title B” buttons 2113 and 2114 are displayed for selecting the database.

The image screen 2102 and 2103 are the manipulation environments of the control terminal 2001 when the DVD-ROM driver 2002 has video data and CD-ROM driver 2005 has car navigation data. The car navigation operator 2004 operates while using the CD-ROM driver 2005 as a database and the video player 2006 operates while using the DVD-ROM driver 2002 as a database. The display screens 2102 and 2103, i.e., manipulation environments for remotely controlling the video player 2006 and the car navigation operator 2004, can be switched therebetween.

In the display screen 2102 which represents the manipulation environment for remotely controlling the video player 2006, only the DVD-ROM driver 2002 is available as the database of the video player 2006. Therefore, only the “Title A” button 2113 for selecting the video data in the DVD-ROM driver 2002 is displayed.

In the display screen 2103 which represents the manipulation environment for remotely controlling the car navigation operator 2004, a “Zoom in” button 2116, a “Zoom out” button 2117 and a cross-shaped button 2118 are displayed.

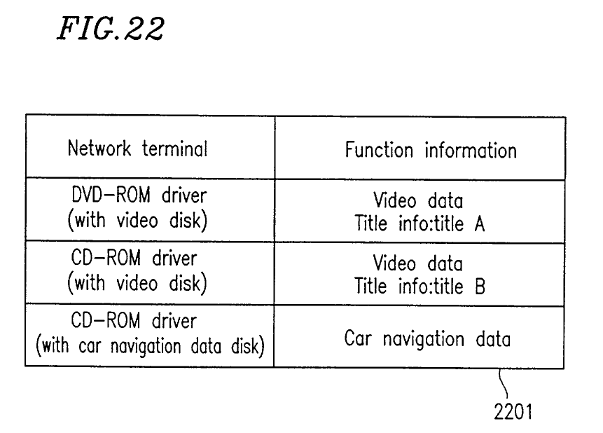

FIG. 22 is a table 2201 showing function information exchanged among the network terminals 2002, 2004, 2005 and 2006.

When a video disk is in the DVD-ROM driver 2002, the DVD-ROM driver 2002 transmits “Video data” as function information. The function information includes text “Title A” which is information of a title of the video data.

When a video data disk is in the CD-ROM driver 2005, the CD-ROM driver 2005 transmits “Video data” as function information. The function information includes text “Title B” which is information of a title of the video data. Furthermore, when a car navigation data disk is in the CD-ROM driver 2005, the CD-ROM driver 2005 transmits “Car navigation data” as function information.

The function information of the CD-ROM driver 2005 changes in the above-described manner.

When both of the DVD-ROM driver 2002 and the CD-ROM driver 2005 include video disks, the video player 2006 receives “video data” from both of the DVD-ROM driver 2002 and the CD-ROM driver 2005. Therefore, the video player 2006 can provide an application for playing video data of “Title A” and “Title B”. When video data disk is inserted only in the DVD-ROM driver 2002, an application for playing video data of title A is provided by receiving function information “video data” from the DVD-ROM driver 2002.

When there is no car navigation data in the CD-ROM driver 2005, the car navigation operator 2004 cannot receive function information “car navigation data”, thereby being unable to provide car navigation application. When the CD-ROM driver 2005 includes a disk of car navigation data, the car navigation operator 2004 is able to receive function information “car navigation data”, thereby providing car navigation application.

Hereinafter, manipulation information which changes according to the function of the network terminal will be described.

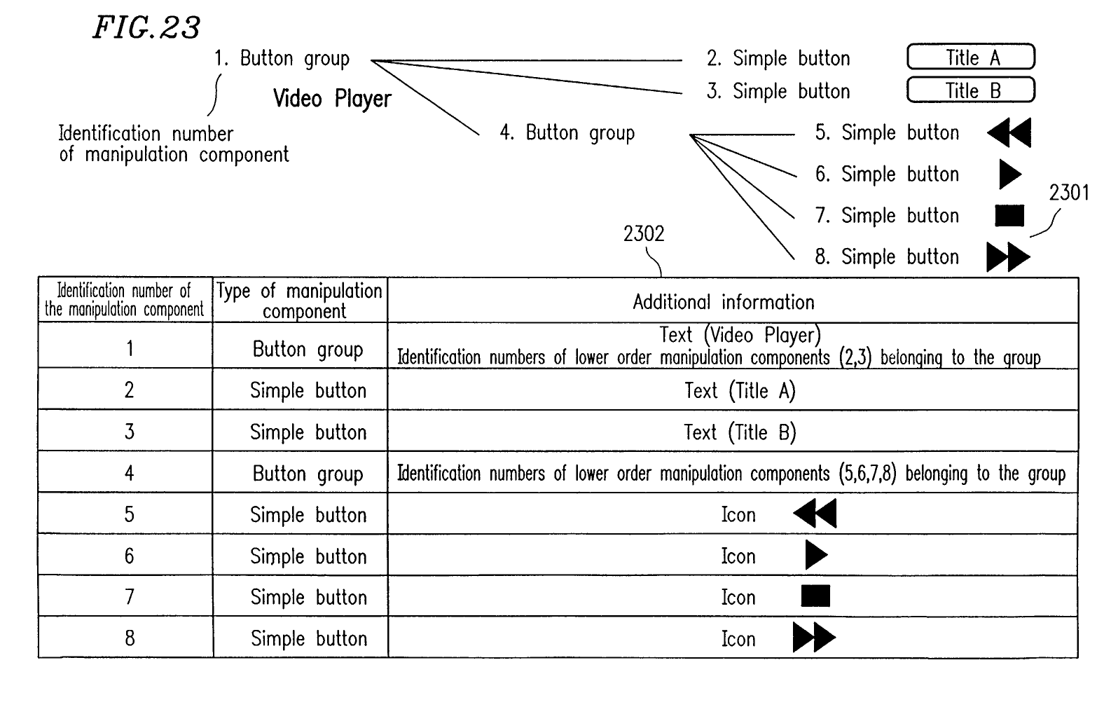

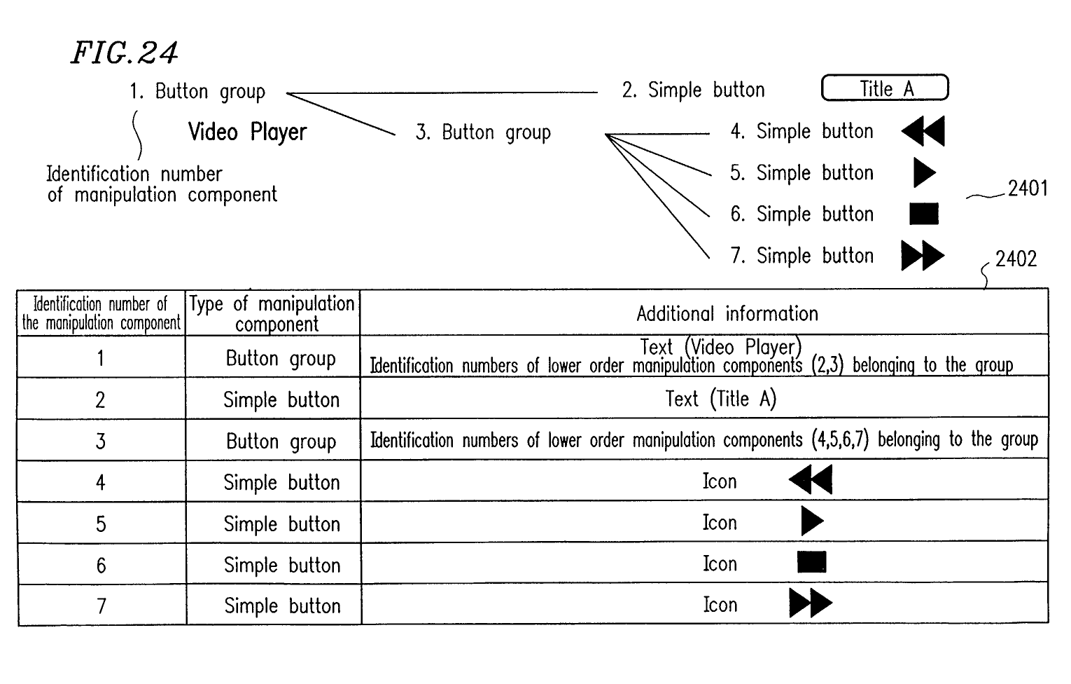

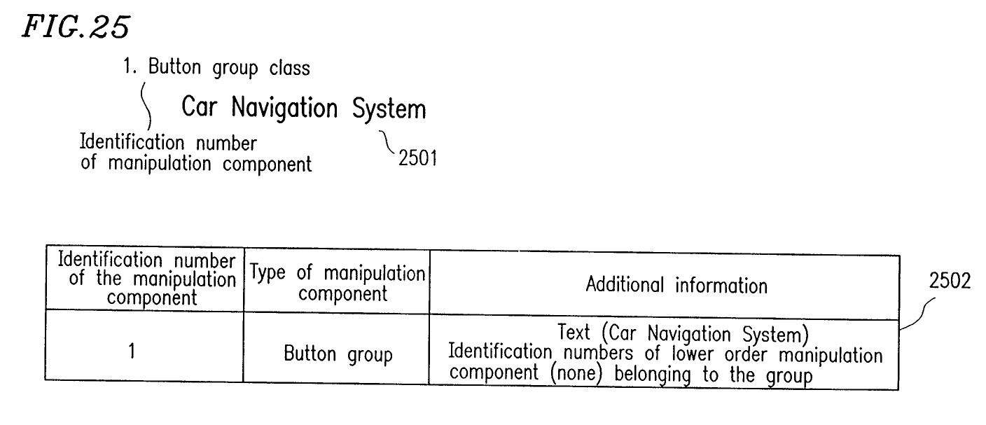

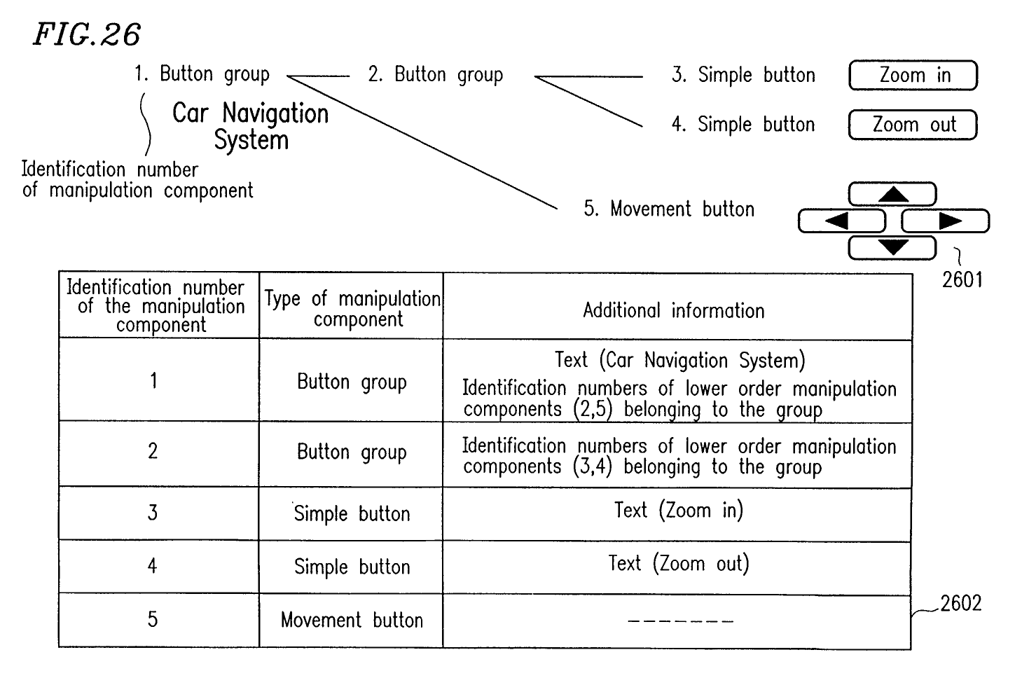

FIGS. 23 and 24 are diagrams showing manipulation information 2302 and 2402 for establishing manipulation environments shown in FIGS. 21A and 21B for remotely controlling the video player 2006. FIGS. 25 and 26 are diagrams showing manipulation information 2502 and 2602 for establishing manipulation environments for remotely controlling the car navigation operator 2004.

FIGS. 23, 24, 25 and 26 further show manipulation components 2301, 2401, 2501 and 2601, respectively.

A structure of manipulation information of the video player 2006, a structure of manipulation information of the car navigation operator 2004 and types of the manipulation components are substantially the same as those in the previously described examples.

Each type of manipulation component included in the manipulation information 2302 and 2402 represents a main button group, at least one of the “Title A” button 2113 and the “Title B” button 2114, the button group (including the rewind, play, stop and fast forward buttons), the rewind button, the play button, the stop button and the fast forward button. Additional information is set so as to correspond to each type of manipulation component. The “Title A” button 2113 and the “Title B” button 2114 are used for selecting a source of the video data.

The manipulation information 2502 representing the manipulation environment for remotely controlling the car navigation operator 2004 shown in FIG. 25 includes only a main button group, and does not represent other buttons or the like.

The manipulation information 2602 representing the manipulation environment for remotely controlling the car navigation operator 2004 shown in FIG. 26 includes manipulation components representing a main button group, a button group including the “Zoom in” button 2116 and the “Zoom out” button 2117 and the cross-shaped button 2118.

When video data disks are set in both of the DVD-ROM driver 2002 and the CD-ROM driver 2005, the video player 2006 transmits manipulation information 2302 to the control terminal 2001 based on the function information from the DVD-ROM driver 2002 and the CD-ROM driver 2005. The manipulation information 2302 includes, as shown in FIG. 23, the “Title A” button 2113 indicating the title of the video data in the DVD-ROM driver 2002 and the “Title B” button 2114 indicating the title of the video data in the CD-ROM driver 2005. The video player 2006 uses text of titles included in the function information of the DVD-ROM driver 2002 and the CD-ROM driver 2005.

Furthermore, when a video data disk is set in the DVD-ROM driver 2002 and no video data disk is set in the CD-ROM driver 2005, the video player 2006 transmits manipulation information 2402 to the control terminal 2001 based on the function information from the DVD-ROM driver 2002 and the CD-ROM driver 2005. The manipulation information 2402 includes, as shown in FIG. 24, the “Title A” button 2113 indicating the title of the video data in the DVD-ROM driver 2002.

When video data disks are set in neither of the DVD-ROM driver 2002 and the CD-ROM driver 2005, titles A and B are not included in the manipulation information.

When no car navigation data disk is set in the CD-ROM driver 2005 such that function information “car navigation data” cannot be received, the manipulation information of the car navigation operator 2004 only includes the main group of the car navigation.

When a car navigation data disk is set in the CD-ROM driver 2005 such that function information “car navigation data” can be received from the CD-ROM driver 2005, the manipulation information 2602 is provided to the control terminal 2001. The manipulation information 2602 includes, as shown in FIG. 26, the “Zoom in” button 2116, the “Zoom out” button 2117 and the cross-shaped button 2118.

According to the fourth example of the present invention, the network terminals 2005 and 2006 determine whether or not the application thereof can be realized based on function information transmitted from other network terminals. The network terminals then generate manipulation information corresponding to the determined application and provide the manipulation information thereof to the control terminal 2001.

Hereinafter, a process of changing the manipulation environment of the control terminal 2001 by changing the manipulation information transmitted from the network terminals 2005 and 2006 will be described.

Now both of the DVD-ROM driver 2002 and the CD-ROM driver 2005 include video data disks.

When video data disks are inserted in both of the DVD-ROM driver 2002 and the CD-ROM driver 2005, the video player 2006 receives function information “video data” from both of the DVD-ROM driver 2002 and the CD-ROM driver 2005, thereby determining that the application of the video player can be realized. Accordingly, the video player 2006 transmits the manipulation information 2302 to the control terminal 2001. The car navigation operator 2004 does not receive function information “car navigation data”, and therefore determines that the application for car navigation system cannot be realized. Accordingly, the car navigation operator 2004 transmits the manipulation information 2502 shown in FIG. 25 in which no actual manipulation component is included, to the control terminal 2001. As a result, the control terminal 2001 recognizes the presence of the car navigation operator 2004 but determines that the application of the car navigation system cannot be provided.

The control terminal 2001 receives the manipulation information 2302 from the video player 2006 and the manipulation information 2502 from the car navigation operator 2004, and establishes the manipulation environment represented by display screen 2101 shown in FIG. 21A.

Now the video data disk in the CD-ROM driver 2005 is replaced with a car navigation data disk.

When the car navigation data disk is inserted in the CD-ROM driver 2005, function information “car navigation data” is transmitted from the CD-ROM driver 2005 to the car navigation operator 2004 and the video player 2006.

Based on the function information, the car navigation operator 2004 determines that the application of the car navigation system can be realized, and transmits the manipulation information 2602 shown in FIG. 26 to the control terminal 2001. Based on the manipulation information 2602, the control terminal 2001 confirms that the manipulation environment for remotely controlling the car navigation system can be realized.

Based on the function information from the CD-ROM driver 2005, the video player 2006 determines that video data is no longer supplied from the CD-ROM driver 2005, and transmits the manipulation information 2402 shown in FIG. 24 where the “Title B” button is omitted to the control terminal 2201. Based on the manipulation information 2402, the control terminal 2001 determines that the “Title B” button is omitted.

As a result, the control terminal 2001 re-establishes the manipulation environment 2102 (FIG. 21B) instead of the manipulation environment 2101.

Analysis of the manipulation information by a CPU of the control terminal 2001, and establishment of the manipulation environments are substantially the same as those in the previously described examples.

Operations performed when buttons are selectively manipulated are substantially the same as those in the previously described examples.

According to the fourth example of the present invention, after a manipulation requesting signal is transmitted from the control terminal 2001 to the network terminal 2005 and 2006 providing the application, a command instructing an operation needs to be transmitted from the network terminal 2005 and 2006 to other network terminals.

For example, in the display screen 2101 (FIG. 21A), when the user selects the “Title A” button 2113, a manipulation requesting signal including an identification number 5 indicating the “Title A” button 2113 is transmitted from the control terminal 2001 to the video player 2006. In response to this manipulation requesting signal, the video player 2006 reproduces a title corresponding to “Title A”. Specifically, the video player 2006 transmits a video data transmission request to the DVD-ROM driver 2002 in which the video data of title A is set. In response to this request, the DVD-ROM driver 2002 transmits the video data to the video player 2006. The video player 2006 receives the video data and reproduces the video data.

Various commands are set in the network terminals in advance, and are transmitted and received in known steps.

As described above, according to the fourth example of the present invention, the application is realized with a plurality of network terminals, and a manipulation environment corresponding to the application is established. In response to the change in the network terminals, function information is transmitted and received among the network terminals so as to change the application. By transmitting manipulation information corresponding to the application to the control terminal, the manipulation environment in the control terminal is changed as well.

According to the fourth example of the present invention, the car navigation operator and video player are illustrated as the network terminals. The present invention, however, is not limited thereto, and is applicable when an application is provided by other types of network terminals.

Furthermore, according to the fourth example of the present invention, buttons are used as manipulation elements. The present invention, however, is not limited thereto, and is equally applicable when other elements (e.g., speech recognition elements or voice guiding elements) are used for manipulation.

Various other modifications will be apparent to and can be readily made by those skilled in the art without departing from the scope and spirit of this invention. Accordingly, it is not intended that the scope of the claims appended hereto be limited to the description as set forth herein, but rather that the claims be broadly construed.

What is claimed is:

1. A network control system, comprising:
a network terminal; and
a control terminal, wherein
the network terminal transmits to the control terminal manipulation information indicating a type of at least one manipulation component and a manipulation requesting signal corresponding to the manipulation component, receives from the control terminal the manipulation requesting signal, and performs an operation corresponding to the manipulation requesting signal upon receipt of the manipulation requesting signal from the control terminal; and
the control terminal includes at least one manipulation component, receives and analyzes the manipulation information from the network terminal, selects the type of the manipulation component indicated by the manipulation information, corresponds the selected manipulation component and the manipulation requesting signal indicated by the manipulation information, thereby establishing a manipulation environment for controlling the network terminal, and, when the manipulation component is selectively manipulated, transmits the manipulation requesting signal to the network terminal.

2. A network control system according to claim 1, wherein a predetermined manipulation component of the at least one manipulation component predeterminedly corresponds to a predetermined operation of the network terminal.

3. A network control system according to claim 1, wherein the at least one manipulation component comprises a physical manipulation button of the control terminal.

4. A network control system according to claim 1, wherein the at least one manipulation component comprises a manipulation button displayed on a display section of the control terminal.

5. A network control system according to claim 1, wherein the at least one manipulation component comprises manipulation components belonging to a manipulation component group, and the control terminal collectively processes the manipulation component of the manipulation component group.

6. A network control system according to claim 1, comprising a plurality of network terminals, at least one of which identifies an application which can be realized by exchanging function information among the plurality of network terminals; transmits to the control terminal manipulation information indicating a type of at least one manipulation component for controlling the function and a manipulation requesting signal corresponding to the manipulation component, receives the manipulation requesting signal from the control terminal, and performs an operation corresponding to the manipulation requesting signal upon receipt of the manipulation requesting signal from the control terminal.

7. A network control system according to claim 1, wherein the control terminal is a remote controller for remotely controlling the network terminal.

8. A network terminal which is controlled by a control terminal including at least one manipulation component, wherein, the network terminal transmits to the control terminal manipulation information indicating a type of at least one manipulation component and a manipulation requesting signal corresponding to the manipulation component, receives manipulation requesting signal, and performs an operation corresponding to the manipulation requesting signal upon receipt of the manipulation requesting signal from the control terminal.

9. A network terminal according to claim 8, wherein a predetermined manipulation component of the at least one manipulation component of the control terminal predeterminedly corresponds to a predetermined operation of the network terminal.

10. A network terminal according to claim 8, wherein the at least one manipulation component comprises a manipulation components belonging to a manipulation component group, and the control terminal collectively processes the manipulation component of the manipulation component group.

11. A network terminal according to claim 8, wherein:
the network terminal identifies an application which can be realized by exchanging function information among a plurality of network terminals, transmits to the control terminal manipulation information indicating a type of at least one manipulation component for controlling the function and a manipulation requesting signal corresponding to the manipulation component, and performs an operation corresponding to the manipulation requesting signal upon receipt of the manipulation requesting signal from the control terminal.

12. A network terminal which is controlled by a control terminal including at least one manipulation component, comprising:
a memory section for storing manipulation information indicating a type of the at least one manipulation component and a manipulation requesting signal corresponding to the manipulation component;
a two-way communication section for transmitting to the control terminal the manipulation information stored in the memory section, and receiving the manipulation requesting signal from the control terminal; and
a control section for performing an operation corresponding to the manipulation requesting signal in response to the manipulation requesting signal received by the two-way communication section.

13. A control terminal for controlling a network terminal which performs an operation in response to a manipulation requesting signal, wherein the control terminal including at least one manipulation component receives and analyzes manipulation information from the network terminal and selects a type of the manipulation component indicated by the manipulation information, corresponds the selected manipulation component and the manipulation requesting signal indicated by the manipulation information, thereby establishing a manipulation environment for controlling the network terminal, and, when the manipulation component is selectively manipulated, transmits the manipulation requesting signal to the network terminal.

14. A control terminal according to claim 13, wherein a predetermined manipulation component of the at least one manipulation component predeterminedly corresponds to a predetermined operation of the network terminal.

15. A control terminal according to claim 13, wherein the at least one manipulation component comprises a physical manipulation button of the control terminal.

16. A control terminal according to claim 13, wherein the at least one manipulation component comprises a manipulation button displayed on a display section of the control terminal.

17. A control terminal according to claim 13, wherein the at least one manipulation component comprises manipulation components belonging to a manipulation component group, and the control terminal collectively processes the manipulation component of the manipulation component group.

18. A control terminal according to claim 13, wherein the control terminal is a remote controller for remotely controlling the network terminal.

19. A control terminal for controlling a network terminal which performs an operation in response to a manipulation requesting signal, comprising:
at least one manipulation component;
a two-way communication section for receiving manipulation information from the network terminal and transmitting a manipulation requesting signal to the network terminal; and
a control section which analyzes the manipulation information received via the two-way communication system, selects a type of the manipulation component indicated by the manipulation information, corresponds the selected manipulation component and the manipulation requesting signal indicated by the manipulation information, thereby establishing a manipulation environment for controlling the network terminal, and, when the manipulation component is selectively manipulated, transmits the manipulation requesting signal to the network terminal via the two-way communication section.

20. A network control system, comprising:
a plurality of network terminals, at least one of which identifies an application which can be realized by exchanging function information among the plurality of network terminals, transmits to the control terminal manipulation information indicating a manipulation environment for controlling the function and a manipulation requesting signal corresponding to the manipulation component, receives the manipulation requesting signal from the control terminal, and performs an operation corresponding to the manipulation requesting signal upon receipt of the manipulation requesting signal from the control terminal; and
a control terminal which receives and analyzes the manipulation information, establishes the manipulation environment indicated by the manipulation information, and when the manipulation environment is manipulated intended for the function, transmits the manipulation requesting signal to at least one of the network terminals.

21. A plurality of network terminals which are controlled by a control terminal including at least one manipulation component, wherein at least one of the plurality of network terminals identifies an application which can be realized by exchanging function information among the plurality of network terminals, and transmits to the control terminal manipulation information indicating a manipulation environment for controlling the function and a manipulation requesting signal, and performs an operation corresponding to the function upon receipt of the manipulation requesting signal from the control terminal.
